(19) United States
(12) Patent Application Publication
(10) Pub. No.: US 2026/0205622 A1
(43) Pub. Date: Jul. 16, 2026

(54) INFORMATION PROCESSING DEVICE AND METHOD

(71) Applicant: Sony Group Corporation, Tokyo (JP)

(72) Inventors: Ryohei TAKAHASHI, Kanagawa (JP); Mitsuhiro HIRABAYASHI, Tokyo (JP)

(73) Assignee: Sony Group Corporation, Tokyo (JP)

(21) Appl. No.: 19/138,676

(22) PCT Filed: Jan. 22, 2024
(86) PCT No.: PCT/JP2024/001644

§ 371 Date: Jun. 13, 2025

Related U.S. Application Data
(60) Provisional application No. 63/440,833, filed on Jan. 24, 2023.

(51) Int. Cl. H04N 19/59; H04N 19/44; H04N 19/54; H04N 19/597

(52) U.S. Cl. CPC H04N 19/59; H04N 19/44; H04N 19/54; H04N 19/597

(57) ABSTRACT

The present disclosure relates to an information processing device and a method capable of suppressing a reduction in random accessibility while suppressing a reduction in coding efficiency.

Random access metadata for performing random access on mesh data is generated on the basis of a current sample that is an inter-mesh sample; and the random access metadata is stored in a content file that stores the mesh data. Furthermore, random access is controlled on the basis of the random access metadata for performing the random access on the basis of the current sample that is an inter-mesh sample, the random access metadata being stored in the content file that stores the mesh data, and reproduction of the mesh data is started by the random access. The present disclosure can be applied to, for example, an information processing device, an information processing method, or the like.

### TECHNICAL FIELD

The present disclosure relates to an information processing device and a method, and more particularly, to an information processing device and a method capable of suppressing a reduction in random accessibility while suppressing a reduction in coding efficiency.

### BACKGROUND ART

Conventionally, there has been an International Organization for Standardization base media file format (ISOBMFF), which is a file container specification of the international standard technology of moving image compression Moving Picture Experts Group-4 (MPEG-4) (see, for example, Non-Patent Document 1 and Non-Patent Document 2).

Furthermore, as a coding method of a mesh that is 3D data representing a three-dimensional structure of an object by connection with vertices, there has been video-based dynamic mesh coding (V-DMC) (see, for example, Non-Patent Document 3 to Non-Patent Document 6).

In recent years, establishment of a method of storing a bit stream encoded by the V-DMC (also referred to as a V-DMC bit stream) in the International Organization for Standardization base media file format (ISOBMFF) or the like and delivering the bit stream is expected. For example, it can be assumed that ISO/IEC 23090-10 (see, for example, Non-Patent Document 7), which is a distribution technology standard of V-PCC, is extended and standardized. In this case, the V-DMC bit stream is stored in the track of the ISOBMFF.

### CITATION LIST

### Non-Patent Document

Non-Patent Document 1:“Information technology—Coding of audio-visual objects—Part 12: ISO base media file format, TECHNICAL CORRIGENDUM 1”, ISO/IEC FDIS 14496-12:2020(E), ISO/IEC 14496-12:2015/Cor.1, ISO/IEC JTC 1/SC 29/WG 11, 2016/6/3, ISO/IEC 14496-12:2022, 7th edition, 2022-01
Non-Patent Document 2:“Information technology—Coding of audio-visual objects—Part 15: Carriage of network abstraction layer (NAL) unit structured video in the ISO base media file format”, ISO/IEC FDIS 14496-15: 2014(E), ISO/IEC JTC 1/SC 29/WG 11, 2014/1/13, ISO/IEC 14496-15:2019, 5th edition, 2019-09
Non-Patent Document 3: Khaled Mammou, Jungsun Kim, Alexis Tourapis, Dimitri Podborski, Krasimir Kolarov, “[V-CG] Apple's Dynamic Mesh Coding CfP Response”, ISO/IEC JTC 1/SC 29/WG 7m 59281 , April 2022
Non-Patent Document 4: Jungsun Kim, Alexis Tourapis, Dimitri Podborski, Khaled Mammou, “VDMC support in the V3C framework”, ISO/IEC JTC 1/SC 29/WG 7m 60748 , Oct 2022
Non Patent Document 5: Alexis Tourapis, Jungsun Kim, Dimitri Podborski, Khaled Mammou, “Base mesh data substream format for VDMC”, ISO/IEC JTC 1/SC 29/WG 7 m60362, July 2022
Non Patent Document 6:“WD 1.0 of V-DMC”, ISO/IEC JTC 1/SC 29/WG 07N 0486 , MDS 22184, 2022-11-16
Non-Patent Document 7:“Text of ISO/IEC FDIS 23090-10 Carriage of Visual Volumetric Video-based Coding Data”, ISO/IEC JTC 1/SC 29/WG 03N 00241 , 2021/8/20, ISO/IEC 23090-10: 2022, 1st edition, 2022-05

### SUMMARY OF THE INVENTION

### Problems to be Solved by the Invention

However, the mesh (base mesh in the case of V-DMC) may include one or more submeshes. Due to this submesh configuration, there has been a possibility that the frequency of random access point (RAP) in the entire bit stream is reduced and random accessibility is reduced. Reducing RAP can be suppressed by reducing the number of samples to be subjected to inter coding and increasing the number of samples to be subjected to intra coding, but in this case, there has been a possibility that coding efficiency is reduced.

The present disclosure has been made in view of such a situation, and an object thereof is to enable suppression of a reduction in random accessibility while suppressing a reduction in coding efficiency.

### Solutions to Problems

An information processing device according to one aspect of the present technology is an information processing device including: a random access metadata generation unit that generates random access metadata for performing random access on mesh data on the basis of a current sample that is an inter-mesh sample; and a storage unit that stores the random access metadata in a content file that stores the mesh data.

An information processing method according to one aspect of the present technology is an information processing method including: generating random access metadata for performing random access on mesh data on the basis of a current sample that is an inter-mesh sample; and storing the random access metadata in a content file that stores the mesh data.

An information processing device according to another aspect of the present technology is an information processing device including: a random access reproduction control unit that controls random access on the basis of random access metadata for performing the random access on the basis of a current sample that is an inter-mesh sample, the random access metadata being stored in a content file that stores mesh data, and a reproduction processing unit that starts reproduction of the mesh data by the random access.

An information processing method according to another aspect of the present technology is an information processing method including: controlling random access on the basis of random access metadata for performing the random access on the basis of a current sample that is an inter-mesh sample, the random access metadata being stored in a content file that stores mesh data, and starting reproduction of the mesh data by the random access.

In the information processing device and the method according to one aspect of the present technology, random access metadata for performing random access on mesh data on the basis of a current sample that is an inter-mesh sample is generated; and the random access metadata is stored in a content file that stores the mesh data.

In the information processing device and the method according to another aspect of the present technology, random access is controlled on the basis of random access metadata for performing the random access on the basis of a current sample that is an inter-mesh sample, the random access metadata being stored in a content file that stores mesh data, and reproduction of the mesh data is started by the random access.

### BRIEF DESCRIPTION OF DRAWINGS

FIG. 1 is a diagram for explaining a mesh.

FIG. 2 is a diagram for explaining V-DMC.

FIG. 3 is a diagram for explaining a submesh.

FIG. 4 is a diagram for explaining sync sample.

FIG. 5 is a diagram illustrating an example of a method of storing a bit stream obtained by encoding mesh data in a file container and distributing the bit stream.

FIG. 6 is a diagram illustrating a main track configuration example of a content file.

FIG. 7 is a diagram illustrating an example of random access metadata.

FIG. 8 is a diagram illustrating an example of random access control.

FIG. 9 is a diagram illustrating an example of random access control.

FIG. 10 is a diagram illustrating an example of random access control.

FIG. 11 is a diagram illustrating an example of random access metadata.

FIG. 12 is a diagram illustrating an example of random access control.

FIG. 13 is a diagram illustrating an example of random access metadata.

FIG. 14 is a diagram illustrating an example of random access control.

FIG. 15 is a diagram illustrating an example of random access metadata.

FIG. 16 is a diagram illustrating an example of random access control.

FIG. 17 is a diagram illustrating an example of random access metadata.

FIG. 18 is a diagram illustrating an example of random access control.

FIG. 19 is a diagram illustrating an example of random access metadata.

FIG. 20 is a diagram illustrating a configuration example of a Matroska media container.

FIG. 21 is a block diagram illustrating a main configuration example of a file generation device.

FIG. 22 is a block diagram illustrating a main configuration example of a V-DMC encoding unit.

FIG. 23 is a flowchart illustrating an example of a flow of file generation processing.

FIG. 24 is a flowchart illustrating an example of a flow of the V-DMC encoding processing.

FIG. 25 is a block diagram illustrating a main configuration example of a reproduction device.

FIG. 26 is a block diagram illustrating a main configuration example of a V-DMC decoding unit.

FIG. 27 is a flowchart illustrating an example of a flow of reproduction processing.

FIG. 28 is a flowchart illustrating an example of a flow of V-DMC decoding processing.

FIG. 29 is a flowchart illustrating an example of a flow of random access reproduction processing.

FIG. 30 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be given in the following order.
1. Documents and the like Supporting Technical Content and Technical Terms
2. V-DMC and Distribution thereof
3. Transmission and Control of Random Access Metadata
4. First Embodiment (File Generation Device)
5. Second Embodiment (Reproduction Device)
6. Supplementary Note

### 1. Documents and the Like Supporting Technical Content and Technical Terms

The scope disclosed in the present technology includes, in addition to the contents disclosed in the embodiments, contents described in following Non-Patent Documents and the like known at the time of filing, the contents of other documents referred to in following Non-Patent Documents and the like.
Non-Patent Document 1: (As described above)
Non-Patent Document 2: (As described above)
Non-Patent Document 3: (As described above)
Non-Patent Document 4: (As described above)
Non-Patent Document 5: (As described above)
Non-Patent Document 6: (As described above)
Non-Patent Document 7: (As described above)
Non Patent Document 8:
   https://www.matroska.org/index.html

That is, the contents described in the above-described Non Patent Documents, the contents of other documents referred to in the above-described Non Patent Documents, and the like are also basis for determining the support requirement.

### 2. V-DMC and Distribution Thereof

### <Mesh>

Conventionally, as 3D data representing a three-dimensional structure of a three-dimensional structure object (object having a three-dimensional shape), there has been known a mesh (mesh) representing a three-dimensional shape of an object surface by forming polygons by vertices and connections (also referred to as edges).

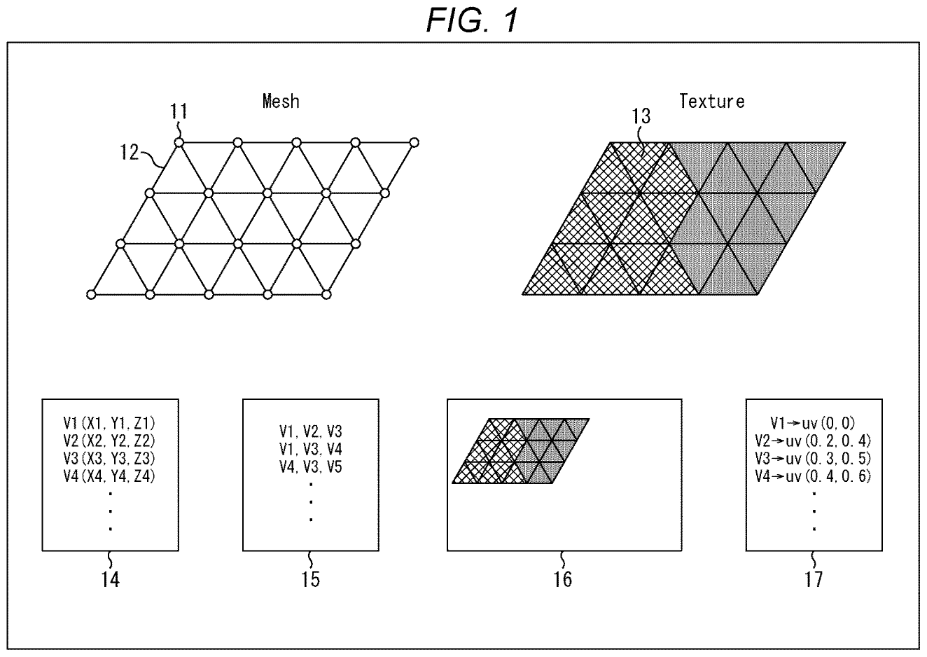

As illustrated in the upper left side of FIG. 1, in the mesh, vertices 11 and connections 12 connecting the vertices 11 form polygonal planes (polygons). In the following description, it is assumed that the polygon has a triangular shape. The surface of the object having the three-dimensional structure, that is, the three-dimensional shape of the object is expressed by the polygon (also referred to as a face). Note that a texture 13 can be attached (also referred to as applied) to each face of the mesh.

The mesh data includes, for example, information as illustrated in the lower part of FIG. 1. Vertex information 14 illustrated first from the left in the lower part of FIG. 1 is information indicating a three-dimensional position (three-dimensional coordinates (X, Y, Z)) of each vertex 11 constituting the mesh. Connection information 15 illustrated second from the left in the lower part of FIG. 1 is information indicating each connection (edge) 12 constituting the mesh. A texture image 16 illustrated third from the left in the lower part of FIG. 1 is map information of the texture 13 attached to each face. A UV map 17 illustrated fourth from the left in the lower part of FIG. 1 is information indicating a correspondence relationship between the vertex 11 and the texture 13. In the UV map 17, coordinates (UV coordinates) of each vertex 11 in the texture image 16 are indicated.

Note that the mesh data can change in the time direction like a moving image of 2D data. That is, the mesh data can have a structure in which frames including mesh data representing three-dimensional structures at different timings are continuous.

### <V-DMC>

As a coding method of such a mesh, for example, there is video-based dynamic mesh coding (V-DMC) as disclosed in Non-Patent Document 3 to Non-Patent Document 6.

In V-DMC, a mesh to be encoded (referred to as an original mesh in the present specification) is expressed by a base mesh having low definition (that is, coarse) than the original mesh and a displacement vector of a division point obtained by subdividing the base mesh, and the base mesh and the displacement vector are encoded. For example, a dynamic mesh stream generated by camera capture, the dynamic mesh (Dynamic Mesh) stream being (Non-registered) mesh data having a structure that changes every frame, is to be encoded.

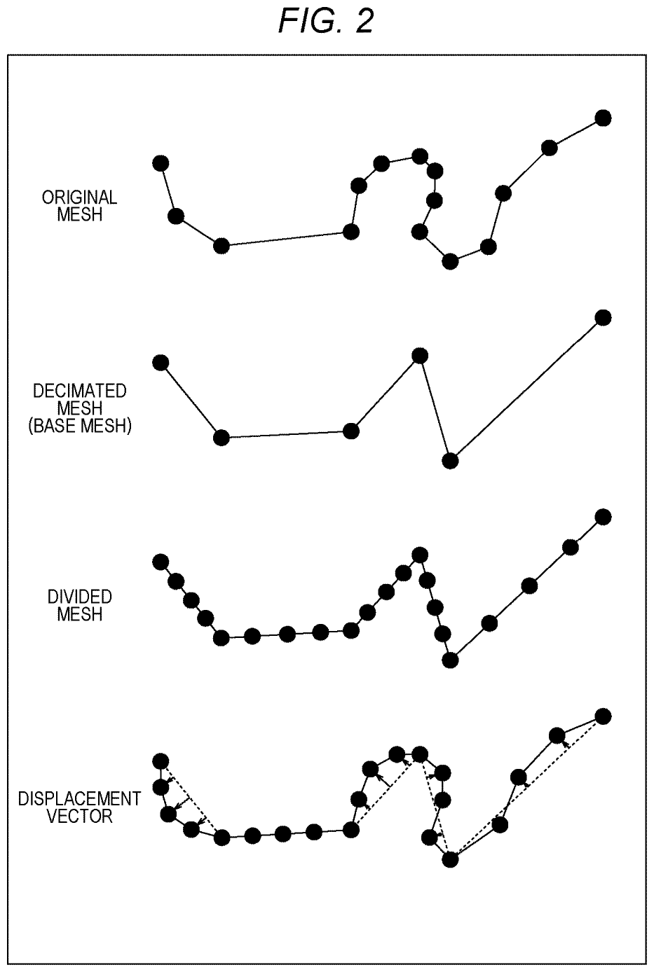

For example, it is assumed that there is an original mesh as illustrated in the uppermost part of FIG. 2. In FIG. 2, a black dot indicates a vertex, and a line connecting the black dots indicates a connection (edge). As described above, the mesh originally forms a surface (polygon) by vertices and edges in a space, but here, for convenience of description, the mesh is described as a vertex group linearly (in series) connected in a plane.

By decimating some vertices of the original mesh, a coarse (low definition) mesh as illustrated in the second part from the top in FIG. 2 is formed. This is referred to as a base mesh.

By subdividing each polygon of this base mesh, vertices and edges are added as illustrated in the third part from the top in FIG. 2. For example, by this subdivision, vertices can be added by the number obtained by decimating the original mesh. That is, by subdividing the base mesh, a mesh having the same number of vertices as the original mesh are obtained. In the present specification, vertices added by such subdivision is also referred to as division points.

However, the connections have been updated when the vertices of the original mesh are decimated, and division points are formed on theses updated connections (edges). Therefore, even if the number of vertices is made the same as that of the original mesh by subdivision, the positions of the vertices of the subdivided base mesh (the third part from the top in FIG. 2) are different from the positions of the vertices of the original mesh (the uppermost part in FIG. 2). In other words, as illustrated in the lowermost part of FIG. 2, ideally, the original mesh can be restored by moving (displacing) the positions of the vertices of the subdivided base mesh to the vertex positions of the original mesh. In the present specification, indicating such displacement (movement) of the vertex as a vector is referred to as a displacement vector.

That is, ideally, the original mesh can be expressed as a base mesh and a displacement vector. By expressing the original mesh as the base mesh and the displacement vector in this manner, the number of polygons (that is, the number of vertices and the number of edges) is reduced. Therefore, by encoding the base mesh and the displacement vector instead of encoding the original mesh, it is possible to suppress a reduction in the coding efficiency (increase in the amount of code).

That is, in V-DMC, V-DMC data including a base mesh, a displacement vector, an attribute (texture), and atlas information is generated from 3D data such as the mesh data as illustrated in FIG. 1, and the V-DMC data is encoded. The atlas information is information necessary for reconstructing the mesh, and includes, for example, information indicating a correspondence relationship between the base mesh, the displacement vector, and the texture. For example, the atlas information may include information that associates patches of a mesh with patches of an attribute, such as the UV map 17 of FIG. 1.

At the time of encoding the V-DMC data, the base mesh, the displacement vector, the attribute (texture), and the atlas information constituting the V-DMC data are encoded, and the respective bit streams (coded data) are generated. Then, the stream of the base mesh, the stream of the displacement vector, the stream of the attribute (texture), and the stream of the atlas information are set as substreams, and one bit stream (also referred to as a V-DMC bit stream) is generated.

As described above, since the mesh data can change in the time direction, the mesh data has a structure in the time direction (continuous frame structure). Therefore, in V-DMC, the mesh data is divided and processed according to the structure in the time direction. The processing unit in the time direction is referred to as a sample. That is, encoding and decoding are performed using one frame or a plurality of consecutive frames of the mesh data as one sample. In general, one frame of the mesh data is one sample.

The samples may be intra coded independently of other samples, or may be inter coded using other samples (other frames) as key samples (key frames).

The atlas information is encoded by a predetermined method. The displacement vector is packed into a frame image (also referred to as a displacement map or a geometry map) and encoded as a moving image (also referred to as a displacement video or a geometry video) using a coding scheme for a moving image. The attribute (texture) is packed into a frame image (also referred to as a texture image or an attribute map) and encoded as a moving image (also referred to as a texture video or an attribute video) by using a coding scheme for a moving image. In the case of intra coding, the base mesh is encoded independently of other samples by a predetermined coding scheme (for example, Draco or the like), and in the case of inter coding, a difference from a key sample is derived and the difference is encoded. Note that, in a case where there is no difference between the sample to be processed and the key sample (in a case where the sample to be processed is the same as the key sample), the encoding can be skipped.

When the V-DMC bit stream is decoded, each substream of the base mesh, the displacement vector, the attribute (texture), and the atlas information is decoded by a decoding method corresponding to a respective one of the encoding methods, and the atlas information, the base mesh, the displacement vector, and the texture are restored (generated). Then, as described above, the base mesh is subdivided on the basis of the atlas information, the displacement vectors are applied to the vertices (that is, the vertices are displaced), and the texture is applied to the faces, so that the mesh is reconstructed (a restored mesh is generated).

### <Distribution of V-DMC Bit Stream>

In recent years, establishment of a method of storing such a V-DMC stream in the International Organization for Standardization base media file format (ISOBMFF) or the like and distributing the V-DMC bit stream is expected. For example, as described in Non-Patent Document 1 and Non-Patent Document 2, the ISOBMFF is a file container specification of the international standard technology of moving image compression “Moving Picture Experts Group-4 (MPEG-4)”. For example, it can be assumed that ISO/IEC 23090-10, which is the distribution technology standard of V-PCC as described in Non-Patent Document 7, is extended and a V-DMC bit stream is stored in the ISOBMFF. In this case, the V-DMC bit stream is stored in the track of the ISOBMFF. For example, it is conceivable to store substreams of the atlas information, the base mesh, the displacement vector, and the attribute in the respective different tracks of the ISOBMFF.

### <Submesh>

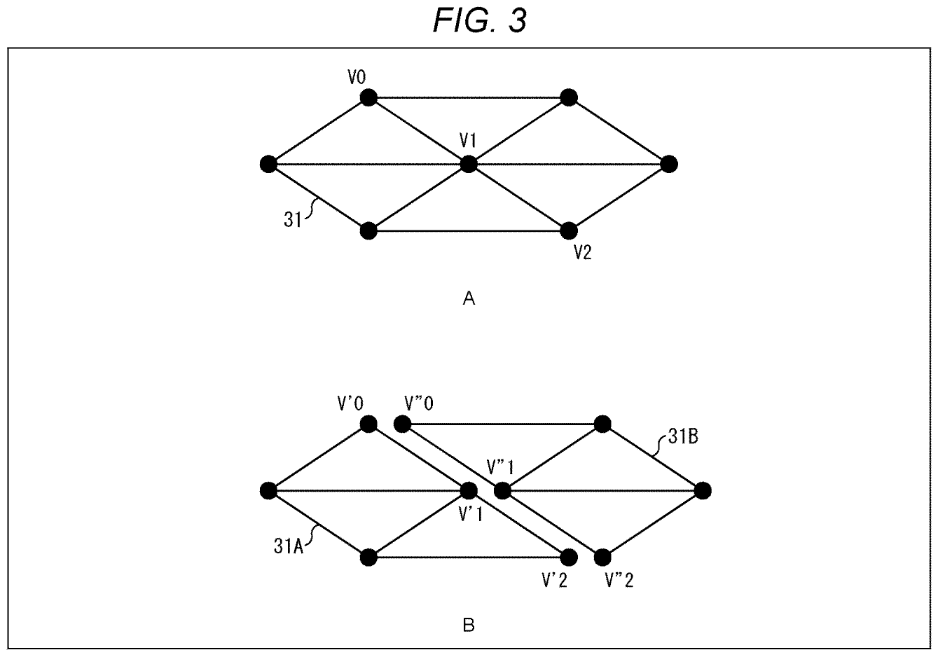

Incidentally, the mesh (base mesh in the case of V-DMC) may include one or more submeshes. The submesh is a unit of encoding processing in the spatial direction (area direction). That is, the submeshes can be encoded independently of each other. For example, if a mesh 31 illustrated in A of FIG. 3 is divided into a submesh 31A and a submesh 31B as illustrated in B of FIG. 3, the submesh 31A and the submesh 31B can be encoded independently of each other. As a result, the submesh 31A and the submesh 31B can be decoded independently of each other. That is, only the submesh 31A can be decoded, or only the submesh 31B can be decoded. That is, only a desired part of the mesh can be decoded, and an unnecessary increase in the decoding processing amount can be suppressed. As a result, an increase in the load and processing time of the decoding processing can be suppressed.

### <Random Access Control>

However, due to this submesh configuration, there has been a possibility that the frequency of random access point (RAP) of the entire bit stream is reduced and random accessibility is reduced.

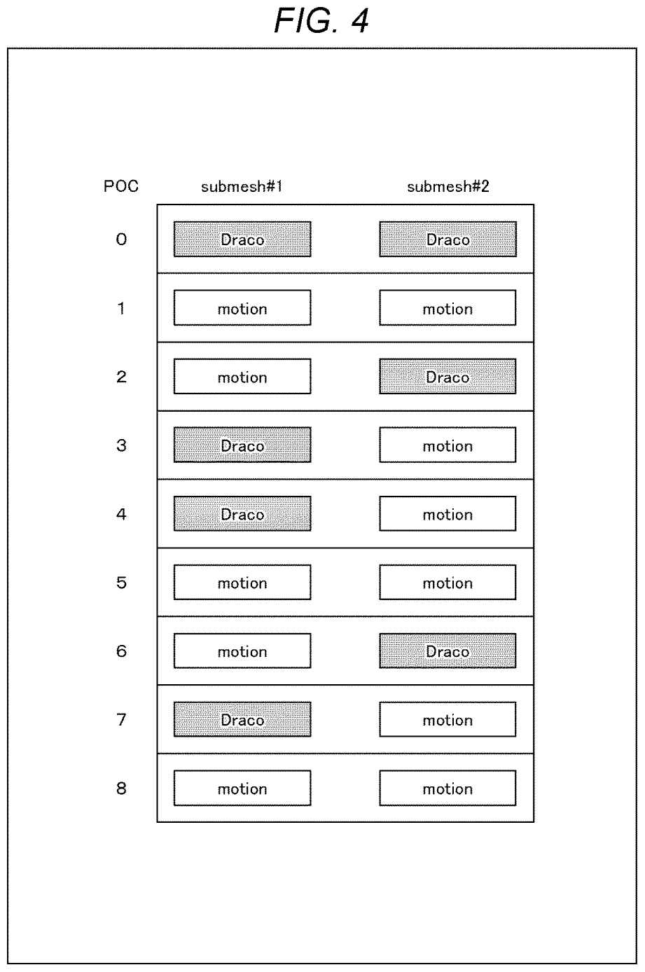

FIG. 4 is a diagram illustrating a configuration example of a bit stream obtained by encoding mesh data and stored in the ISOBMFF. The bit stream illustrated in FIG. 4 is a bit stream obtained by encoding mesh data having two submeshes (submesh #1, submesh #2), and has nine samples from picture order counts (POC) 0 to POC8. Note that the POC indicates the decoding order of each sample.

A sample corresponding to the submesh is also referred to as a subsample. In the case of the example of FIG. 4, each sample has a subsample corresponding to the submesh #1 and a subsample corresponding to the submesh #2. Squares denoted “Draco” indicate intra-coded subsamples, and squares denoted “motion” indicate inter-coded subsamples.

In the intra-coded sample, only the sample can normally decoded. On the other hand, in order to normally decode the inter-coded sample, the key sample (for example, the immediately preceding sample) needs to have been normally decoded. However, as described above, in the case of mesh data, each sample is encoded for each submesh. Therefore, in order to normally decode a certain sample, it is only required that all the subsamples constituting the sample can be normally decoded. For example, since the subsample of the submesh #1 of POC4 in the bit stream of FIG. 4 is intra coded, it is only required to start decoding from POC4 in order to normally decode this subsample. On the other hand, the subsample of the submesh #2 of POC4 is inter-coded, and it is only required to start decoding from POC2 in order to normally decode this subsample. That is, in order to normally decode the sample of POC4, it is only required to start decoding from POC2.

In the case of 2D data, in the ISOBMFF, a sample in the middle of a sequence specified as a RAP (also referred to as a sync sample) is accessed, and random access reproduction in which access is started from the sample can be performed. Samples that can be specified as a sync sample are intra-coded samples.

However, a method of storing mesh data in a file container such as the ISOBMFF has just started to be studied, and there has been no method of realizing random access like 2D data. Even if random access is applied, there has been no method of controlling random access on the basis of a subsample of 3D data at least in a file container such as the ISOBMFF. That is, in the case of a bit stream of the mesh data, for example, as in the sample of POC2 in FIG. 4, each submesh may be encoded by a different method, but which and how submesh is encoded in the file container (that is, the encoding structure for each submesh) is not managed. Therefore, for example, as in POC0 in FIG. 4, only a sample in which all subsamples are intra-coded can be specified as the sync sample. That is, in this case, decoding needs to be started from POC0.

As described above, due to the configuration of the submesh, there has been a possibility that the frequency of the RAP of the entire bit stream is reduced. Therefore, there has been a possibility that random accessibility is reduced. Therefore, there has been a possibility that the viewing experience quality of trick reproduction (for example, jumping reproduction, fast-forwarding, rewinding, and the like) is reduced.

Note that a method of suppressing the reduction of RAP by reducing the number of samples to be subjected to inter coding and increasing the number of samples to be subjected to intra coding is conceivable, but in this case, there has been a possibility that coding efficiency of the bit stream is reduced.

### 3. Transmission and Control of Random Access Metadata

### <Method 1>

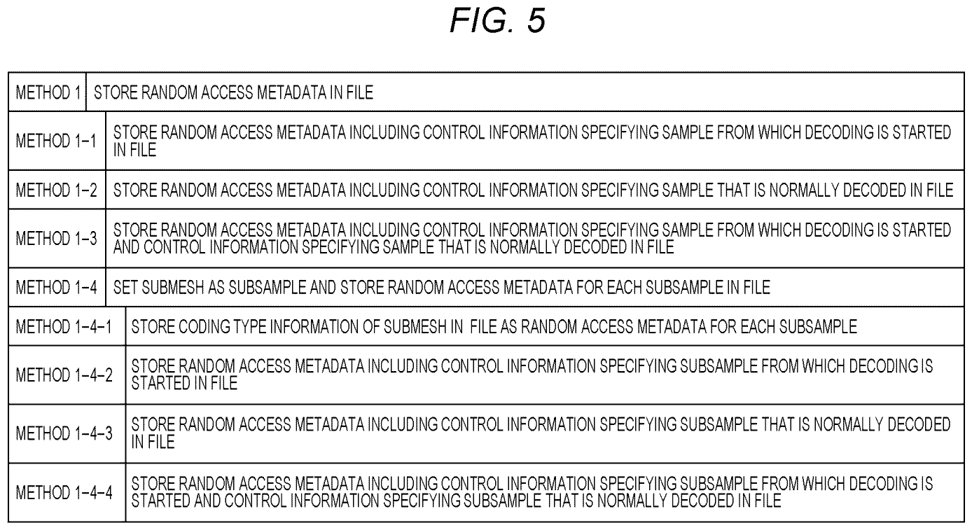

Therefore, in a case where a bit stream obtained by encoding mesh data is stored in a file container, it is possible to suppress a reduction in random accessibility while suppressing a reduction in coding efficiency. For example, as illustrated at the uppermost row of the table in FIG. 5, the random access metadata may be stored in the file (method 1).

Here, the random access metadata is control information for performing random access to the mesh data. More specifically, the random access metadata is control information for performing random access to the mesh data on the basis of a current sample that is a sample to be processed. For example, the random access metadata may be control information for performing random access to the mesh data on the basis of a current sample that is an inter-mesh sample. Here, the inter-mesh sample is a sample including an inter-mesh subsample, and the inter-mesh subsample is a subsample of the inter-coded mesh data. Note that, in the present specification, a subsample of intra-coded mesh data is also referred to as an intra-mesh subsample, and a sample including only the intra-mesh subsample is also referred to as an intra-mesh sample.

For example, a file generation device (first information processing device) that stores a bit stream obtained by encoding mesh data in a file container may include a random access metadata generation unit that generates random access metadata for performing random access on the mesh data on the basis of a current sample that is an inter-mesh sample, and a storage unit that stores the random access metadata in a content file that stores the mesh data.

Furthermore, a file generation device (first information processing device) that stores a bit stream obtained by encoding mesh data in a file container may generate random access metadata for performing random access on the mesh data on the basis of a current sample that is an inter-mesh sample, and may store the random access metadata in a content file that stores the mesh data.

As a result, the first information processing device can also set the inter-mesh sample as a sync sample (that is, RAP). That is, the first information processing device can also set a sample other than the sample including only the intra-coded subsamples as a sync sample (that is, RAP). Therefore, the first information processing device can generate a content file that can be randomly accessed to more various samples while suppressing a reduction in coding efficiency. That is, the first information processing device can suppress a reduction in random accessibility while suppressing a reduction in coding efficiency. For example, the first information processing device can suppress a reduction in the viewing experience quality of the trick reproduction (for example, jumping reproduction, fast-forwarding, rewinding, and the like) while suppressing a reduction in coding efficiency.

For example, a reproduction device (second information processing device) that decodes a bit stream stored in a file container and reproduces mesh data may include a random access reproduction control unit that controls random access on the basis of random access metadata for performing random access on the basis of a current sample that is an inter-mesh sample, the random access metadata being stored in a content file that stores the mesh data, and a reproduction processing unit that starts reproduction of the mesh data by the random access.

Furthermore, a reproduction device (second information processing device) that decodes a bit stream stored in a file container and reproduces mesh data may control random access on the basis of random access metadata for performing random access on the basis of a current sample that is an inter-mesh sample, the random access metadata being stored in a content file that stores the mesh data, and may start reproduction of the mesh data by the random access.

As a result, the second information processing device can easily (without parsing the bit stream) perform random access to a sample other than the sample including only the intra-coded subsample on the basis of the information (random access metadata) of the content file. Therefore, the second information processing device can perform random access to more various samples of the content file while suppressing a reduction in coding efficiency. That is, the second information processing device can suppress a reduction in random accessibility while suppressing a reduction in coding efficiency. For example, the second information processing device can suppress a reduction in the viewing experience quality of the trick reproduction (for example, jumping reproduction, fast-forwarding, rewinding, and the like) while suppressing a reduction in the coding efficiency.

The random access metadata may be stored anywhere in the content file. For example, in the first information processing device, the storage unit may store the random access metadata in the track that stores the mesh data of the content file. Furthermore, in the second information processing device, the random access metadata may be stored in the track that stores the mesh data in the content file.

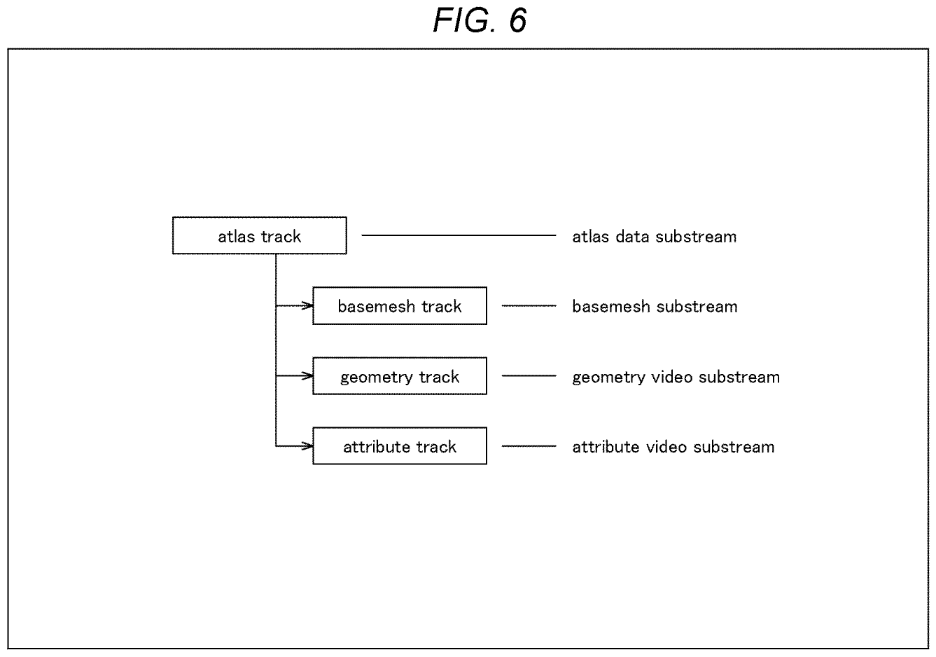

The configuration of the track in the content file may be any configuration. For example, as illustrated in FIG. 6, a substream of the atlas information (atlas data substream), a substream of the base mesh (basemesh substream), a substream of the displacement vector (geometry video substream), and a substream of the attribute (texture) (attribute video substream) may be stored in different tracks. FIG. 6 illustrates an example of a track configuration of the content file. In this example, the substream of the atlas information (atlas data substream) is stored in an atlas track (atlas track). The substream of the base mesh (basemesh substream) is stored in a base mesh track (basemesh track). The substream of the displacement vector (geometry video substream) is stored in a geometry track (geometry track). The substream of the attribute (texture) (attribute video substream) is stored in an attribute track (attribute track).

In a case where the content file has such a track configuration, the random access metadata may be stored in the base mesh track. For example, the random access metadata may be stored in an area that stores metadata of the base mesh track. As a result, the second information processing device can easily perform random access to more various samples of the base mesh by simply referring to the base mesh track. In other words, the first information processing device can easily generate a content file that can be randomly accessed to more various samples of the base mesh only by referring to the base mesh track.

The random access metadata may be stored in the content file in any way. For example, in the first information processing device, the storage unit may store the random access metadata as the parameter of the sample group. Furthermore, in the second information processing device, the random access metadata may be stored in the content file as the parameter of the sample group.

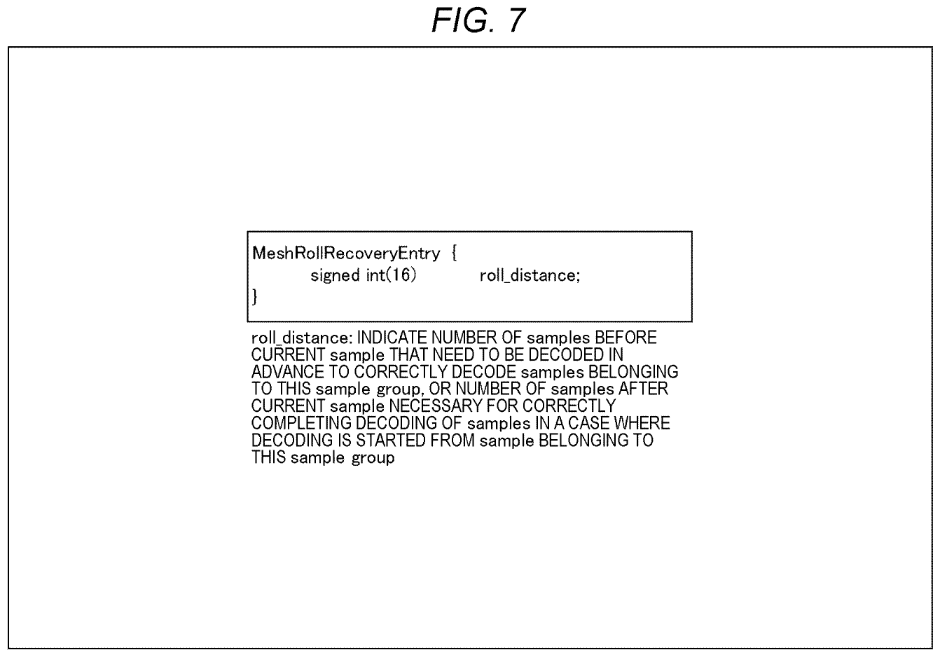

FIG. 7 is a diagram illustrating an example of the random access metadata. As illustrated in FIG. 7, an entry (MeshRollRecoveryEntry) of a sample group may be newly defined as the random access metadata, and control information for performing random access to mesh data may be stored in the entry (MeshRollRecoveryEntry).

The random access metadata may be referred to when a sample corresponding to the random access metadata is decoded. The random access metadata may be set for each sample. Furthermore, the random access metadata may be shared by a plurality of samples. For example, the random access metadata may be set for each predetermined sample section. In this case, the common random access metadata is applied to each sample in the sample section. Furthermore, the random access metadata may be set for the entire sequence. In this case, the common random access metadata is applied to all the samples in the sequence.

Furthermore, the random access metadata may be set only for some samples. For example, the random access metadata may be set only for predetermined samples. For example, in the first information processing device, the random access metadata generation unit may generate the random access metadata corresponding to the inter-mesh sample. Furthermore, in the second information processing device, the random access metadata may correspond to the inter-mesh sample. Note that the random access metadata may be set only for some inter-mesh samples.

The random access metadata can be applied to any mesh data. For example, the random access metadata may be applied to a base mesh of V-DMC. For example, in the first information processing device and the second information processing device, the mesh data may be data of a base mesh having a lower definition than the original mesh, the base mesh being generated by decimating vertices from the original mesh to be encoded including vertices and connections representing a three-dimensional structure of an object. Furthermore, the random access metadata may be applied in a case where the original mesh is set as an encoding target without applying V-DMC and a bit stream of the original mesh is stored in a file container such as the ISOBMFF to be distributed. For example, in the first information processing device and the second information processing device, the mesh data may be data of an original mesh to be encoded including vertices and connections representing a three-dimensional structure of an object.

Furthermore, the specification and name of the file container that stores the bit stream of the mesh data and the random access metadata may be any specification and name. For example, in the first information processing device and the second information processing device, the content file may be a file container compliant with the International Organization for Standardization base media file format (ISOBMFF).

### <Method 1-1>

In a case where the method 1 is applied, for example, as illustrated in the second row from the top of the table in FIG. 5, the random access metadata including the control information specifying the sample from which decoding is started may be stored in the file (method 1-1). In the present specification, this “sample from which decoding is started” is also referred to as a decoding start sample.

For example, in the first information processing device, the random access metadata may include the control information specifying a sample from which decoding is started.

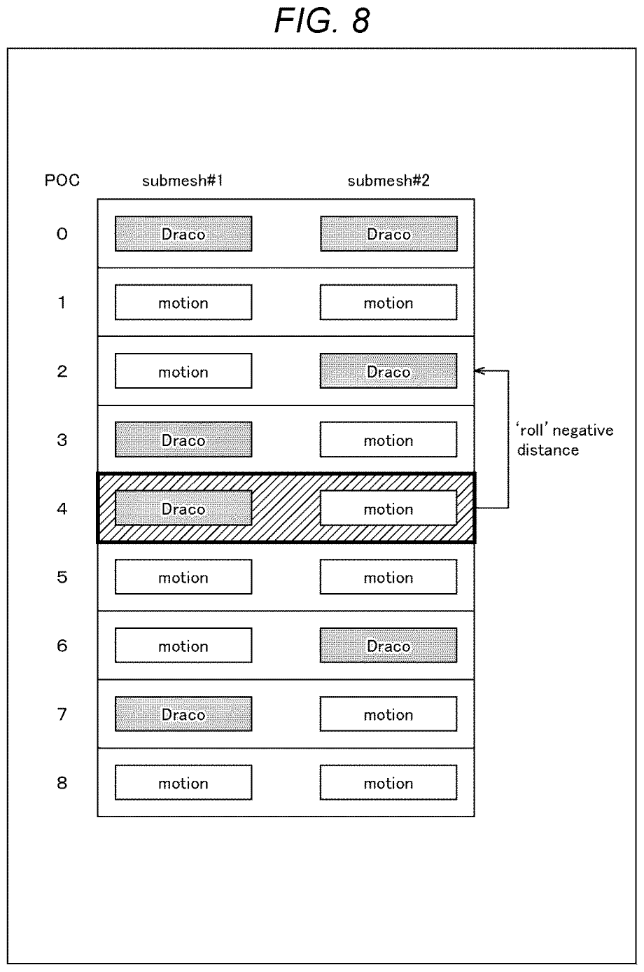

For example, as illustrated in FIG. 8, the control information specifying a decoding start sample for normally decoding the sample of POC4 may be included as the random access metadata corresponding to the sample of POC4. In the case of the example of FIG. 8, for both of the submesh #1 and the submesh #2, there are intra-mesh subsamples in the samples from POC2 to POC4. Therefore, if decoding is started from the sample of POC2, the sample of POC4 can be decoded normally. The control information (‘roll’ negative distance) specifying such a sample of POC2 as a decoding start sample may be included in the random access metadata corresponding to the sample of POC4.

Note that, in the case of the example of FIG. 8, the sample of POC2 is closest to the sample of POC4 as the decoding start sample for normally decoding the sample of POC4. As described above, the random access metadata may include the control information specifying the sample closest to the sample corresponding to the random access metadata among the decoding start samples satisfying the condition (that is, the decoding start sample for normally decoding the sample corresponding to the random access metadata).

In this case, the reproduction device (second information processing device) may start decoding from the decoding start sample specified by the control information. For example, in the second information processing device, the random access metadata may include the control information specifying a sample from which decoding is started. Then, a random access reproduction control unit may start decoding of the mesh data from the sample specified by the control information.

That is, as a result, the inter-mesh sample (in the case of the example of FIG. 8, the sample of POC2) can also be a sync sample (that is, RAP). Therefore, the first information processing device and the second information processing device can suppress a reduction in random accessibility while suppressing a reduction in coding efficiency. For example, the first information processing device and the second information processing device can suppress a reduction in the viewing experience quality of the trick reproduction (for example, jumping reproduction, fast-forwarding, rewinding, and the like) while suppressing a reduction in coding efficiency. In particular, in the case of this method 1-1, normal displaying from the current sample (in the case of the example of FIG. 8, the sample of POC4) can be realized. That is, the image integrity can be prioritized.

Note that the “control information specifying a sample from which decoding is started” included in the random access metadata may have any specification. For example, in the first information processing device and the second information processing device, the control information may specify a sample from which decoding is started by a difference value of the POC from the current sample.

For example, as illustrated in FIG. 7, a parameter “roll_distance” may be defined in MeshRollRecoveryEntry. The parameter “roll_distance” indicates a difference value of the POC between the current sample and a specified sample. Here, the current sample indicates a sample to be processed corresponding to the random access metadata. Furthermore, the specified sample indicates a sample specified by this control information. In the case of the method 1-1, the specified sample indicates a decoding start sample.

Note that the difference value (the difference value of the POC between the current sample and the decoding start sample) may be a value with a positive or negative sign or an absolute value. For example, in the first information processing device and the second information processing device, the “difference value of the POC from the current sample” in the “control information specifying the sample from which decoding is started” described above may be a value with a positive or negative sign or an absolute value. Note that, in a case where the difference value is indicated by a value with a positive or negative sign, the difference value is indicated by a negative value. Furthermore, in a case where the difference value is indicated by an absolute value, the control is performed on the assumption that the specified sample is a sample ahead of the current sample (a sample with a smaller POC).

### <Method 1-2>

In a case where the method 1 is applied, for example, as illustrated in the third row from the top of the table in FIG. 5, the random access metadata including the control information specifying the sample that is normally decoded may be stored in the file (method 1-2). In the present specification, this “sample that is normally decoded” is also referred to as a normally decoded sample.

For example, in the first information processing device, the random access metadata may include the control information specifying a sample that is normally decoded.

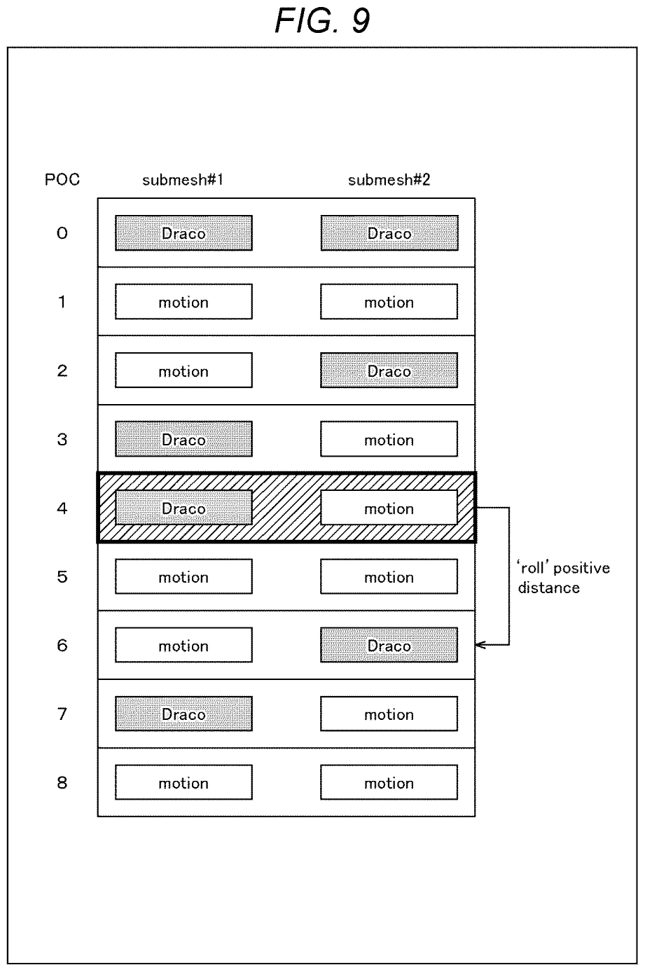

For example, as illustrated in FIG. 9, the control information specifying a normally decoded sample that is normally decoded in a case where decoding is started from the sample of POC4 may be included as the random access metadata corresponding to the sample of POC4. In the case of the example of FIG. 9, regarding the submesh #1, the subsample of POC4 is an intra-mesh subsample. Furthermore, regarding a sample behind POC4 of the submesh #2 (a sample with a larger POC), the subsample of POC6 is an intra-mesh subsample closest to POC4. Therefore, in a case where decoding is started from the sample of POC4, decoding can be performed normally from the sample of POC6. That is, all the subsamples can be normally decoded from the sample of POC6. The control information (‘roll’ positive distance) specifying such a sample of POC6 as a normally decoded sample may be included in the random access metadata corresponding to the sample of POC4.

In this case, the reproduction device (second information processing device) may start decoding from the current sample. For example, in the second information processing device, the random access metadata may include the control information specifying a sample that is normally decoded. Then, the random access reproduction control unit may start decoding of the mesh data from the current sample.

That is, as a result, the inter-mesh sample (in the case of the example of FIG. 9, the sample of POC4) can also be a sync sample (that is, RAP). Therefore, the first information processing device and the second information processing device can suppress a reduction in random accessibility while suppressing a reduction in coding efficiency. For example, the first information processing device and the second information processing device can suppress a reduction in the viewing experience quality of the trick reproduction (for example, jumping reproduction, fast-forwarding, rewinding, and the like) while suppressing a reduction in coding efficiency. In particular, in the case of this method 1-2, decoding and displaying from the current sample (in the case of the example of FIG. 8, the sample of POC4) can be started. Although normal decoding and displaying cannot be performed up to a normally decoded sample (In the case of the example of FIG. 9, the sample of POC6), since it is not necessary to perform decoding from a sample ahead of the current sample, decoding and displaying can be started at a higher speed. That is, low latency can be prioritized.

Note that the “control information specifying a sample that is normally decoded” included in the random access metadata may have any specification. For example, in the first information processing device and the second information processing device, the control information may specify a sample that is normally decoded by a difference value of the POC from the current sample.

For example, as illustrated in FIG. 7, a parameter “roll_distance” may be defined in MeshRollRecoveryEntry. The parameter “roll_distance” indicates a difference value of the POC between the current sample and a specified sample. In the case of the method 1-2, the specified sample indicates a normally decoded sample.

Note that the difference value (the difference value of the POC between the current sample and the normally decoded sample) may be a value with a positive or negative sign or an absolute value. For example, in the first information processing device and the second information processing device, the “difference value of the POC from the current sample” in the “control information specifying a sample that is normally decoded” described above may be a value with a positive or negative sign or an absolute value. Note that, in a case where the difference value is indicated by a value with a positive or negative sign, the difference value is indicated by a positive value. Furthermore, in a case where the difference value is indicated by an absolute value, control is performed on the assumption that the specified sample is a sample behind the current sample (a sample having a larger POC).

### <Method 1-3>

In a case where the method 1 is applied, for example, as illustrated in the fourth row from the top of the table in FIG. 5, the random access metadata including the control information specifying a sample from which decoding is started and the control information specifying a sample that is normally decoded may be stored in the file (method 1-3).

For example, in the first information processing device, the random access metadata may include the first control information specifying a sample from which decoding is started and the second control information specifying a sample that is normally decoded.

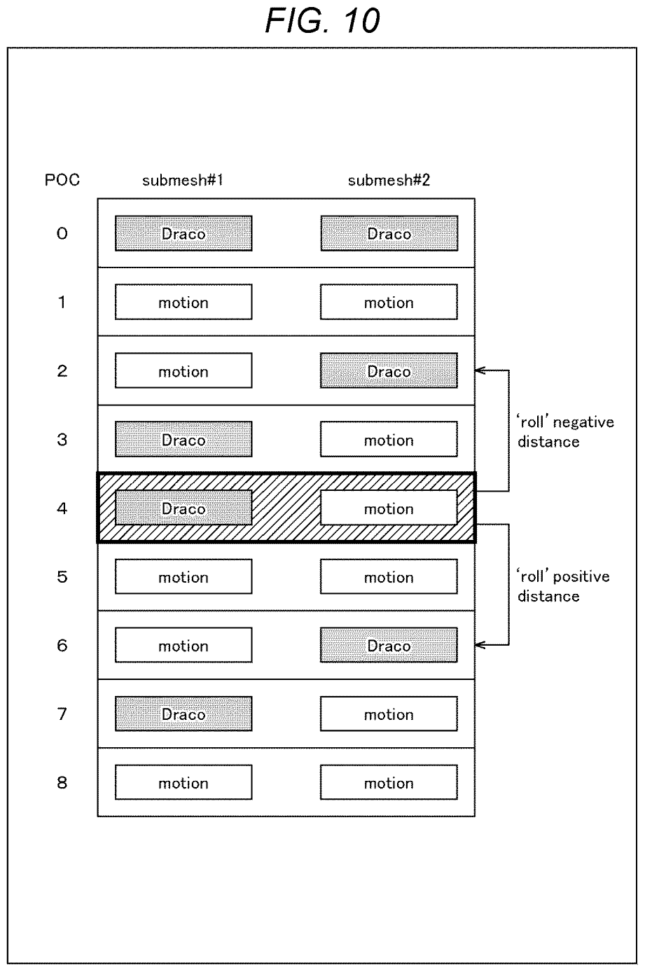

For example, as illustrated in FIG. 10, the random access metadata corresponding to the sample of POC4 may include both the control information specifying the decoding start sample for normally decoding the POC4 sample and the control information specifying the normally decoded sample that is normally decoded in a case where decoding is started from the sample of POC4. In the case of the example of FIG. 10, the control information (‘roll’ negative distance) specifying the sample of POC2 as the decoding start sample and the control information (‘roll’ positive distance) specifying the sample of POC6 as the normally decoded sample are included in the random access metadata corresponding to the sample of POC4.

In this case, the reproduction device (second information processing device) may select whether to start decoding from the decoding start sample specified by the control information or start decoding from the current sample. For example, in the second information processing device, the random access metadata may include the first control information specifying a sample from which decoding is started and the second control information specifying a sample that is normally decoded. Then, the random access reproduction control unit may select whether to control random access on the basis of the first control information or to control random access on the basis of the second control information.

Note that such a selection may be performed according to any information such as an operation mode of the reproduction device (second information processing device) itself, a load state, random access metadata, and the like. For example, the reproduction device (second information processing device) may control random access by using the control information specified by the user, the application, or the like. Furthermore, in a case where the current load is larger than predetermined criteria, the reproduction device (second information processing device) may prioritize low latency, and otherwise may prioritize image integrity. Furthermore, the reproduction device (second information processing device) may control random access on the basis of the second control information in a case where the normally decoded sample is closer to the current sample than the decoding start sample, and may control random access on the basis of the first control information in a case where the normally decoded sample is not closer to the current sample than the decoding start sample. Of course, other selection methods may be used.

That is, as a result, the inter-mesh sample (in the case of the example of FIG. 10, the sample of POC2 or the sample of POC4) can also be a sync sample (that is, RAP). Therefore, the first information processing device and the second information processing device can suppress a reduction in random accessibility while suppressing a reduction in coding efficiency. For example, the first information processing device and the second information processing device can suppress a reduction in the viewing experience quality of the trick reproduction (for example, jumping reproduction, fast-forwarding, rewinding, and the like) while suppressing a reduction in coding efficiency. In particular, in the case of the method 1-3, normal decoding and displaying from the current sample (in the case of the example of FIG. 10, the sample of POC4) can be realized, and normal decoding and displaying from the normally decoded sample (in the case of the example of FIG. 10, the sample of POC6) can be realized. That is, image integrity can be prioritized, and low latency can be prioritized. A more appropriate control method can also be selected according to the situation.

Note that the first control information and the second control information included in the random access metadata may each have any specification. For example, in the first information processing device and the second information processing device, the first control information included in the random access metadata may specify a sample from which decoding is started by a difference value of the picture order count (POC) from the current sample. Furthermore, the second control information included in the random access metadata may specify a sample that is normally decoded by a difference value of the POC from the current sample.

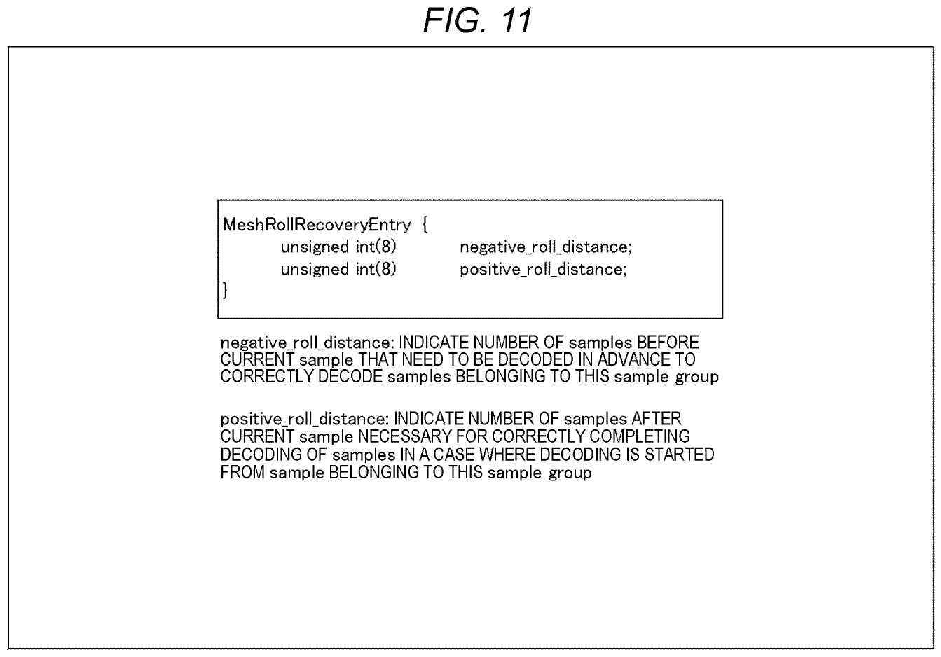

For example, as illustrated in FIG. 11, the parameters “negative_roll_distance” and “positive_roll_distance” may be defined in MeshRollRecoveryEntry. This parameter “negative_roll_distance” indicates the number of samples before the current sample that need to be decoded in advance to correctly decode the samples belonging to this sample group. That is, the parameter “negative_roll_distance” indicates the difference value of the POC between the current sample and the decoding start sample. Furthermore, the parameter “positive_roll_distance” indicates the number of samples after the current sample necessary for correctly completing decoding of samples in a case where decoding is started from a sample belonging to this sample group. That is, the parameter “positive_roll_distance” indicates the difference value of the POC between the current sample and the normally decoded sample.

Note that these difference values (the difference value of the POC between the current sample and the decoding start sample, and the difference value of the POC between the current sample and the normally decoded sample) may be values with a positive or negative sign. For example, in the first information processing device and the second information processing device, the “difference value of the POC from the current sample” in the first control information and the second control information described above may be a value with a positive or negative sign. Note that, In this case, the difference value (the difference value of the POC between the current sample and the decoding start sample) in the first control information is indicated by a negative value, and the difference value (the difference value of the POC between the current sample and the normally decoded sample) in the second control information is indicated by a positive value. Of course, these difference values may be indicated by absolute values. In that case, the control is performed on the assumption that the specified sample corresponding to the first control information is a sample ahead of the current sample (a sample with a smaller POC), and the specified sample corresponding to the second control information is a sample behind the current sample (a sample with a larger POC).

### <Method 1-4>

In a case where the method 1 is applied, for example, as illustrated in the fifth row from the top of the table in FIG. 5, a submesh may be a subsample, and the random access metadata for each subsample may be stored in the file (method 1-4). That is, the content file may manage a bit stream for each submesh as a subsample in the sample. Then, the random access metadata may be set for the subsample.

For example, in the first information processing device, the content file may manage submeshes of mesh data as subsamples. The random access metadata generation unit may generate random access metadata corresponding to the subsample. The storage unit may store the random access metadata corresponding to the subsample in the content file.

At the time of reproduction, a bit stream stored in such a content file may be independently decoded for each subsample. For example, in the second information processing device, the content file may manage a submesh of mesh data as a subsample and store random access metadata corresponding to the subsample. Then, the random access reproduction control unit may control random access to the subsample on the basis of the random access metadata corresponding to the subsample. Moreover, the reproduction processing unit may start reproduction of the mesh data for each subsample by the random access.

As a result, the second information processing device can easily (without requiring parsing of the bit stream) control random access reproduction for each subsample. In other words, the first information processing device can easily (without requiring parsing of the bit stream) generate a content file in which random access reproduction can be controlled for each subsample. Furthermore, by controlling random access for each subsample, decoding of unnecessary subsamples can be further reduced as compared with a case where random access reproduction is controlled for each sample, and an increase in load of decoding processing can be suppressed. Furthermore, more various samples can be randomly accessed. That is, it is possible to suppress a reduction in random accessibility while suppressing a reduction in coding efficiency.

The random access metadata corresponding to this subsample may be stored anywhere in the content file in any manner. For example, the random access metadata may be stored in a subsample information box (SubSampleInformationBox) of the content file. For example, the random access metadata may be stored as a codec specific parameter (codec_specific_parameters) in the subsample information box of the content file. For example, in the first information processing device, the storage unit may store the random access metadata in the subsample information box of the content file. Furthermore, in the second information processing device, the random access metadata may be stored in the subsample information box of the content file. That is, the second information processing device may refer to the random access metadata stored in the subsample information box of the content file at the time of random access reproduction.

<method 1-4-1>

In a case where the method 1-4 is applied, for example, as illustrated in the sixth row from the top of the table in FIG. 5, coding type information of the submesh (submesh_coding_type) may be stored in a file as the random access metadata for each subsample (method 1-4-1).

For example, in the first information processing device and the second information processing device, the random access metadata may include information indicating the coding type of the submesh corresponding to the subsample. Furthermore, in the second information processing device, the random access reproduction control unit may control random access to the subsample on the basis of the coding type.

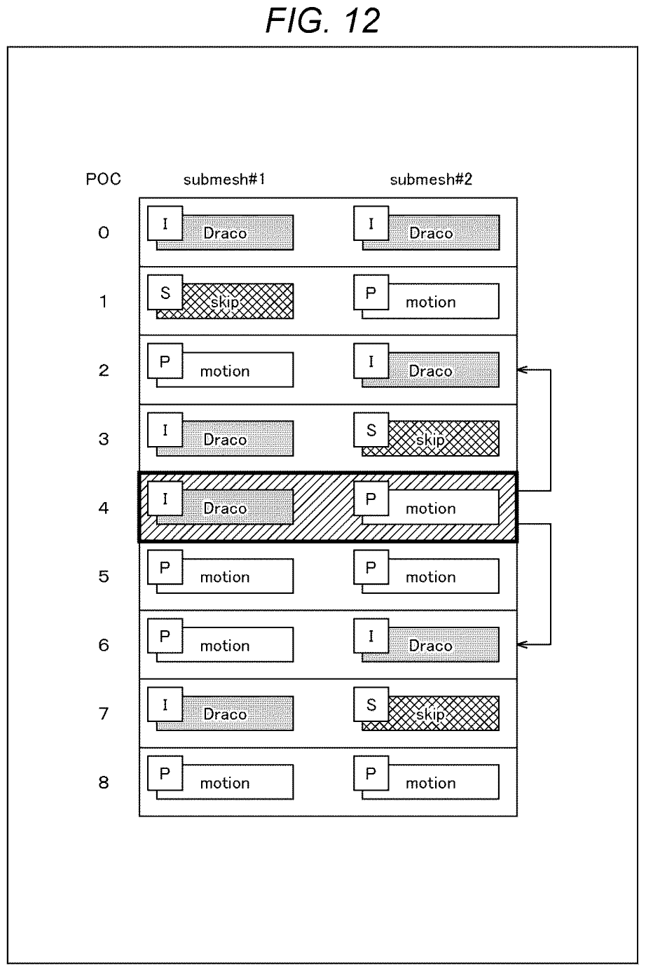

The coding type of the submesh (subsample) may include, for example, intra coding (I), inter coding (P), skipping of coding(S), and the like. For example, as illustrated in FIG. 12, for each subsample, the coding type of the submesh corresponding to the subsample may be indicated as random access metadata. In FIG. 12, “I”, “P”, or “S” attached to each subsample indicates the coding type of the submesh corresponding to the subsample, indicated as the random access metadata.

Since the coding type of the submesh corresponding to each subsample can be known by referring to the random access metadata in this way, the random access reproduction may be controlled according to the coding type.

In the example of FIG. 12, for example, the sample of POC4 is set as a current sample. By referring to the random access metadata, it can be seen that the coding type of the current subsample (that is, the subsample of POC4) to be processed is “I (intra coding)” for the submesh #1. Furthermore, it can be seen that the coding type of the current subsample is “P (inter coding)” for the submesh #2. Furthermore, it can be seen that the subsample of POC2 is a subsample with the coding type of “I (intra coding)” that is before POC4 and closest to POC4. Similarly, it can be seen that the subsample of POC6 is a subsample with the coding type of “I (intra coding)” that is after POC4 and closest to POC4.

That is, if image integrity is prioritized, the reproduction device is only required to start decoding from the current subsample (the subsample of POC4) for the submesh #1, and start decoding from the subsample of POC2 for the submesh #2. With this control, the current sample can be normally decoded and displayed. Furthermore, for example, decoding of unnecessary subsamples with the coding type of “I (intra coding)”, such as the subsamples of POC0 and POC3 corresponding to the submesh #1 and the subsample of POC0 corresponding to the submesh #2, can be omitted. Furthermore, for example, decoding of subsamples with the coding type of “P (inter coding)” the reference destination subsample (a subsample with the coding type of “I (intra coding)”) of which is not decoded, such as the subsample of POC2 corresponding to the submesh #1 and the subsample of POC1 corresponding to the submesh #2, can be omitted. Furthermore, for example, decoding of subsamples with the coding type of “S (coding skip)”, such as the subsample of POC1 corresponding to the submesh #1 and the subsample of POC3 corresponding to the submesh #2, can be omitted. Therefore, an increase in load of the decoding processing can be suppressed. Moreover, such control can be performed on the basis of the random access metadata. That is, such control can be easily realized without requiring parsing of the bit stream.

On the other hand, if low latency is prioritized, the reproduction device is only required to start decoding from the current sample. In this case, the submesh #1 can be normally decoded from the subsample of POC4. Furthermore, the submesh #2 can be normally decoded from the subsample of POC6. Note that, in this case, for example, decoding of subsamples with the coding type of “P (inter coding)” the reference destination subsample (a subsample with the coding type of “I (intra coding)”) of which is not decoded, such as the subsamples of POC4 and POC5 corresponding to the submesh #2, can be omitted. Furthermore, decoding of subsamples with the coding type of “S (skipping coding)” can be omitted. Therefore, an increase in load of the decoding processing can be suppressed. Moreover, such control can be performed on the basis of the random access metadata. That is, such control can be easily realized without requiring parsing of the bit stream.

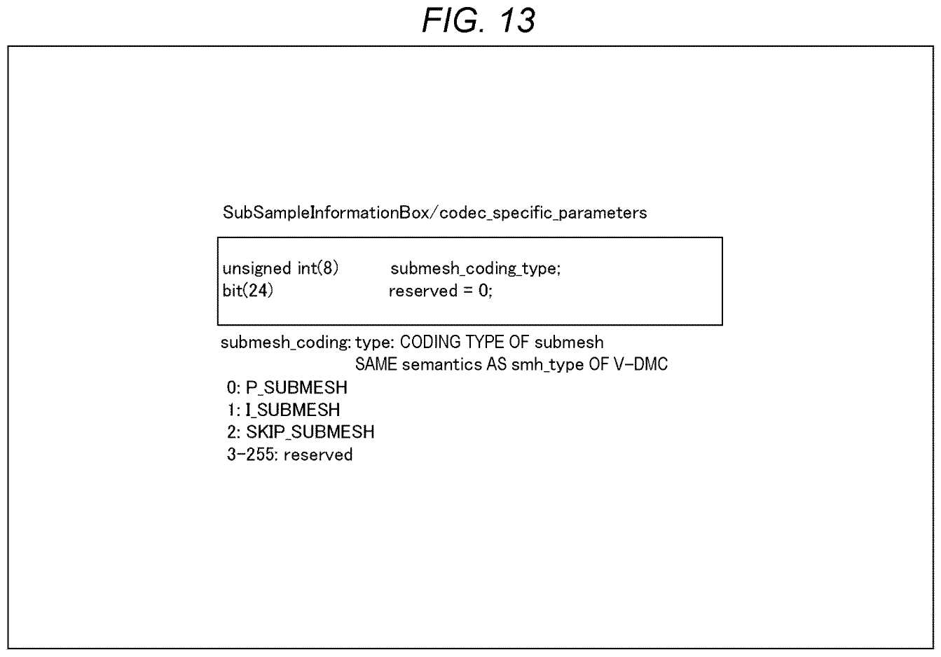

Note that the random access metadata in this case may have any specification. For example, as illustrated in FIG. 13, “submesh_coding_type” may be defined as the codec specific parameter in the subsample information box. The “submesh_coding_type” is a parameter indicating a coding type of the submesh. For example, in a case where submesh_coding_type=0, it may be indicated that the coding type of the submesh is “P (inter coding)”. Furthermore, in a case where submesh_coding_type=1, it may be indicated that the coding type of the submesh is “I (intra coding)”. Furthermore, in a case where submesh_coding_type=2, it may be indicated that the coding type of the submesh is “S (skipping coding)”. Of course, this value is an example, and is not limited to this example. Furthermore, the coding type indicated by this parameter is also optional, and is not limited to this example.

### <Method 1-4-2>

In a case where the method 1-4 is applied, for example, as illustrated in the seventh row from the top of the table in FIG. 5, the random access metadata including the control information specifying the subsample from which decoding is started may be stored in the file (method 1-4-2). That is, the control of the method 1-1 may be performed for each subsample. In the present specification, this “subsample from which decoding is started” is also referred to as a decoding start subsample.

For example, in the first information processing device, the random access metadata may include the control information specifying a subsample from which decoding is started. In this case, the reproduction device (second information processing device) may start decoding from the decoding start sample specified by the control information. For example, in the second information processing device, the random access metadata may include the control information specifying a subsample from which decoding is started. Then, the random access reproduction control unit may start decoding of the mesh data from the subsample specified by the control information.

Note that the “control information specifying a subsample from which decoding is started” included in the random access metadata may have any specification. For example, in the first information processing device and the second information processing device, the control information may specify a subsample from which decoding is started by a difference value of the POC from the current subsample.

Note that the difference value (the difference value of the POC between the current subsample and the decoding start subsample) may be a value with a positive or negative sign or an absolute value. For example, in the first information processing device and the second information processing device, the “difference value of the POC from the current subsample” in the “control information specifying the subsample from which decoding is started” described above may be a value with a positive or negative sign or an absolute value. Note that, in a case where the difference value is indicated by a value with a positive or negative sign, the difference value is indicated by a negative value. Furthermore, in a case where the difference value is indicated by an absolute value, control is performed on the assumption that the decoding start subsample is a subsample ahead of the current subsample (a subsample with a smaller POC).

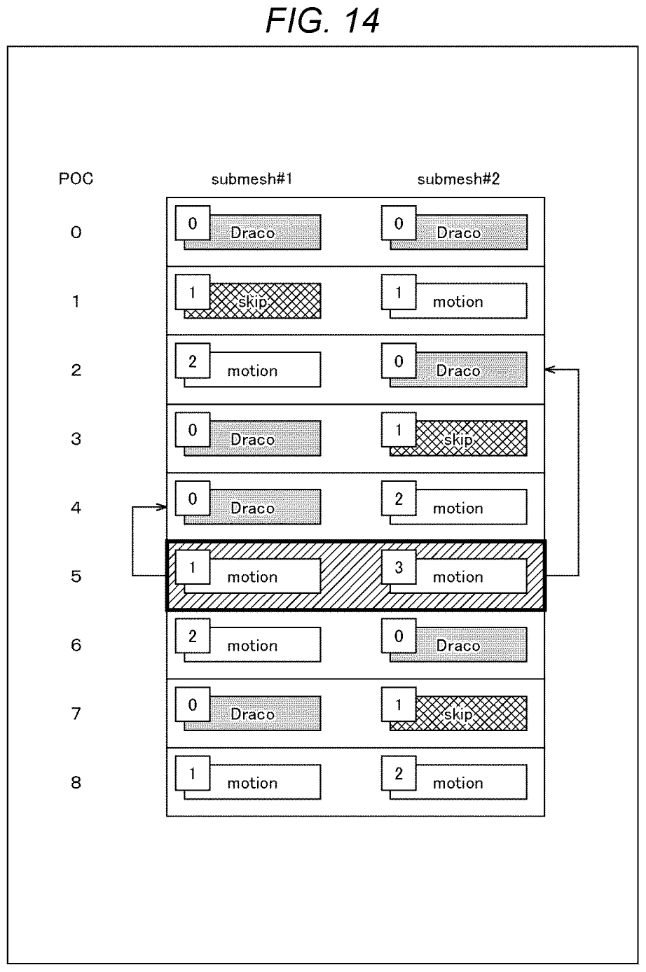

For example, as illustrated in FIG. 14, the control information specifying a decoding start subsample for normally decoding the subsample may be included as the random access metadata corresponding to each subsample. In FIG. 14, the number in the square attached to the left side of each subsample indicates the “difference value (absolute value) of the POC between the current subsample and the decoding start subsample”. For example, the subsample corresponding to the submesh #1 of POC5 is given “1” as the difference value (absolute value). That is, the subsample corresponding to the submesh #1 of POC4 is specified as the decoding start subsample. Furthermore, the subsample corresponding to the submesh #2 of POC5 is given “3” as the difference value (absolute value). That is, the subsample corresponding to the submesh #2 of POC2 is specified as the decoding start subsample. Therefore, in this case, by starting decoding from the subsample of POC4 for the submesh #1 and starting decoding from the subsample of POC2 for the submesh #2, the sample of POC5 can be normally decoded. Similarly, for other samples, a decoding start subsample for normally decoding the subsample is specified as the random access metadata.

Note that, in the case of the example of FIG. 14, the subsample of POC4 is closest to POC5 as the decoding start subsample for normally decoding the subsample corresponding to submesh #1 of POC5. Similarly, the subsample of POC2 is closest to POC5 as the decoding start subsample for normally decoding the subsample corresponding to submesh #2 of POC5. As described above, the random access metadata may include the control information specifying the subsample closest to the subsample corresponding to the random access metadata among the decoding start subsamples satisfying the condition (that is, the decoding start subsample for normally decoding the subsample corresponding to the random access metadata).

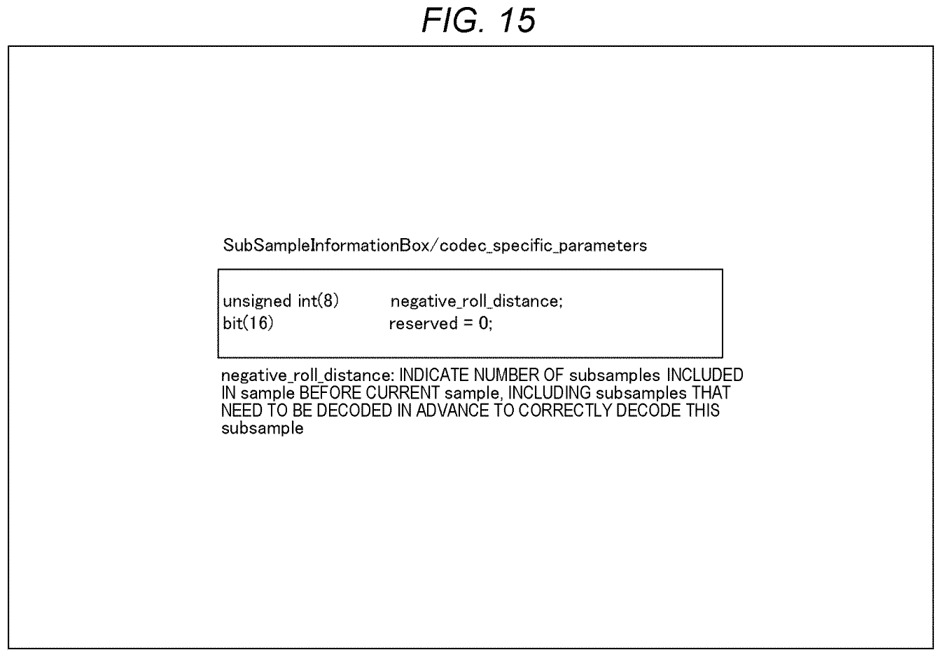

The random access metadata may be stored in the subsample information box, for example, as illustrated in FIG. 15. For example, the random access metadata may be set as the codec specific parameter in the subsample information box. For example, the random access metadata may be defined in the codec specific parameter “negative_roll_distance” defined in the subsample information box may be defined. The parameter “negative_roll_distance” indicates the number of subsamples included in the sample before the current subsample, including subsamples that need to be decoded in advance to correctly decode this subsample. That is, the parameter “negative_roll_distance” indicates the difference value of the POC between the current subsample and the decoding start subsample.

By controlling random access in this manner, the first information processing device and the second information processing device can obtain effects similar to the case of applying the method 1-1. Furthermore, by controlling random access for each subsample, decoding of unnecessary subsamples can be further reduced as compared with a case where random access reproduction is controlled for each sample. For example, decoding of unnecessary subsamples with the coding type of “I (intra coding)” can be omitted, or decoding of subsamples with the coding type of “P (inter coding)” the reference destination subsample (a subsample with the coding type of “I (intra coding)”) of which is not decoded,, can be omitted. Therefore, an increase in load of the decoding processing can be suppressed. Moreover, such control can be performed on the basis of the random access metadata. That is, such control can be easily realized without requiring parsing of the bit stream.

### <Method 1-4-3>

In a case where the method 1-4 is applied, for example, as illustrated in the eighth row from the top of the table in FIG. 5, the random access metadata including the control information specifying the subsample that is normally decoded may be stored in the file (method 1-4-3). That is, the control of the method 1-2 may be performed for each subsample. In the present specification, this “subsample that is normally decoded” is also referred to as a normally decoded subsample.

For example, in the first information processing device, the random access metadata may include the control information specifying a subsample that is normally decoded. In this case, the reproduction device (second information processing device) may start decoding from the current subsample. For example, in the second information processing device, the random access metadata may include the control information specifying a subsample that is normally decoded. Then, the random access reproduction control unit may start decoding of the mesh data from the current subsample.

Note that the “control information specifying a subsample that is normally decoded” included in the random access metadata may have any specification. For example, in the first information processing device and the second information processing device, the control information may specify a subsample that is normally decoded by a difference value of the picture order count (POC) from the current subsample.

Note that the difference value (the difference value of the POC between the current subsample and the normally decoded subsample) may be a value with a positive or negative sign or an absolute value. For example, in the first information processing device and the second information processing device, the “difference value of the POC from the current subsample” in the “control information specifying the subsample that is normally decoded” described above may be a value with a positive or negative sign or an absolute value. Note that, in a case where the difference value is indicated by a value with a positive or negative sign, the difference value is indicated by a positive value. Furthermore, in a case where the difference value is indicated by an absolute value, control is performed on the assumption that the normally decoded subsample is a subsample behind the current subsample (a subsample with a larger POC).

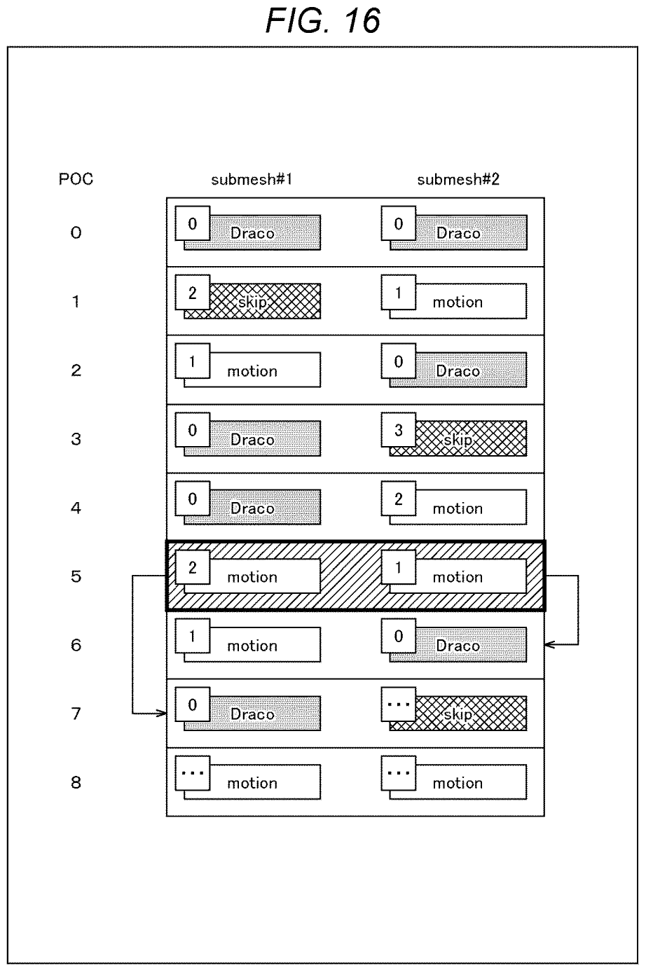

For example, as illustrated in FIG. 16, the control information specifying a subsample that is normally decoded in a case where decoding is started from the subsample may be included as the random access metadata corresponding to each subsample. In FIG. 16, the number in the square attached to the left side of each subsample indicates the “difference value (absolute value) of the POC between the current subsample and the normally decoded subsample”. For example, the subsample corresponding to the submesh #1 of POC5 is given “2” as the difference value (absolute value). That is, the subsample corresponding to the submesh #1 of POC7 is specified as the normally decoded subsample. Furthermore, the subsample corresponding to the submesh #2 of POC5 is given “1” as the difference value (absolute value). That is, the subsample corresponding to the submesh #2 of POC6 is specified as the normally decoded sample. Therefore, in this case, by starting decoding from the sample of POC5, the submesh #1 can be normally decoded from the subsample of POC7 and the submesh #2 can be normally decoded from the subsample of POC6. Similarly, for the other samples, a normally decoded subsample in a case where decoding is started from the subsample is specified as the random access metadata.

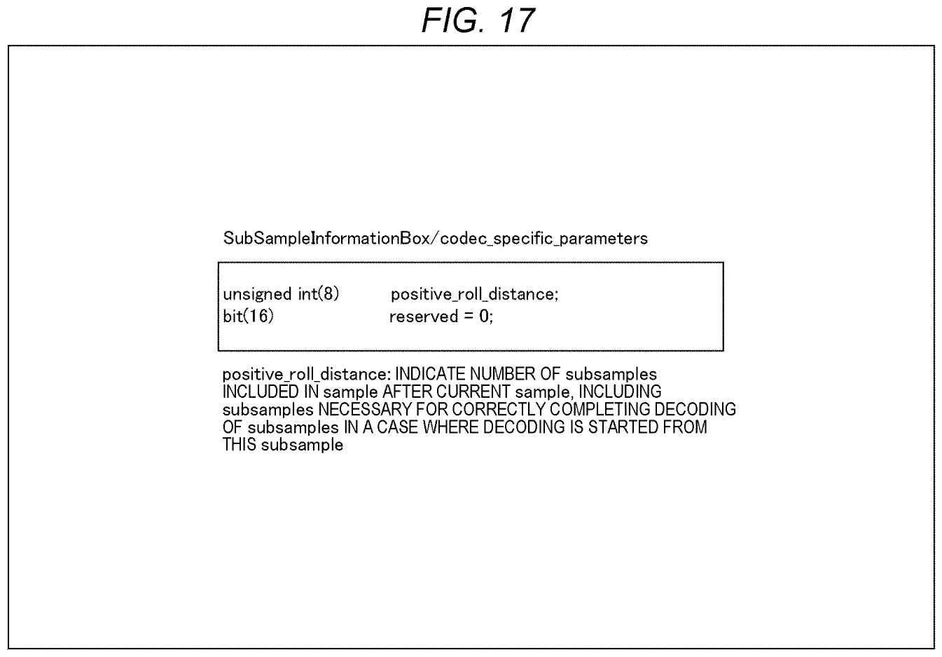

The random access metadata may be stored in the subsample information box, for example, as illustrated in FIG. 17. For example, the random access metadata may be set as the codec specific parameter in the subsample information box. For example, the random access metadata may include the codec specific parameter “positive_roll_distance” defined in the subsample information box. The parameter “positive_roll_distance” indicates the number of subsamples included in the sample after the current sample including the subsamples necessary for correctly completing decoding of subsamples in a case where decoding is started from this subsample. That is, the parameter “positive_roll_distance” indicates the difference value of the POC between the current subsample and the normally decoded subsample.

By controlling random access in this manner, the first information processing device and the second information processing device can obtain effects similar to the case of applying the method 1-2. Furthermore, by controlling random access for each subsample, decoding of unnecessary subsamples can be further reduced as compared with a case where random access reproduction is controlled for each sample. For example, decoding of unnecessary subsamples with the coding type of “I (intra coding)” can be omitted, or decoding of subsamples with the coding type of “P (inter coding)” the reference destination subsample (a subsample with the coding type of “I (intra coding)”) of which is not decoded,, can be omitted. Therefore, an increase in load of the decoding processing can be suppressed. Moreover, such control can be performed on the basis of the random access metadata. That is, such control can be easily realized without requiring parsing of the bit stream.

### <Method 1-4-4>

In a case where the method 1-4 is applied, for example, as illustrated in the lowermost row of the table in FIG. 5, the random access metadata including the control information specifying a subsample from which decoding is started and the control information specifying a subsample that is normally decoded may be stored in the file (method 1-4-4). That is, the control of the method 1-3 may be performed for each subsample.

For example, in the first information processing device, the random access metadata may include the first control information specifying a subsample from which decoding is started and the second control information specifying a subsample that is normally decoded. In this case, the reproduction device (second information processing device) may select whether to start decoding from the decoding start subsample specified by the random access metadata or start decoding from the current subsample. For example, in the second information processing device, the random access metadata may include the first control information specifying a sample from which decoding is started and the second control information specifying a sample that is normally decoded. Then, the random access reproduction control unit may select whether to control random access on the basis of the first control information or to control random access on the basis of the second control information.

Note that such a selection may be performed according to any information such as an operation mode of the reproduction device (second information processing device) itself, a load state, random access metadata, and the like. For example, the reproduction device (second information processing device) may control random access by using the control information specified by the user, the application, or the like. Furthermore, in a case where the current load is larger than predetermined criteria, the reproduction device (second information processing device) may prioritize low latency, and otherwise may prioritize image integrity. Furthermore, the reproduction device (second information processing device) may control random access on the basis of the second control information in a case where the normally decoded subsample is closer to the current subsample than the decoding start subsample, and may control random access on the basis of the first control information in a case where the normally decoded subsample is not closer to the current subsample than the decoding start subsample. Of course, other selection methods may be used.

Note that the first control information and the second control information included in the random access metadata may each have any specification. For example, in the first information processing device and the second information processing device, the first control information included in the random access metadata may specify a subsample from which decoding is started by a difference value of the POC from the current subsample. Furthermore, the second control information included in the random access metadata may specify a subsample that is normally decoded by a difference value of the POC from the current subsample.

Note that these difference values (the difference value of the POC between the current subsample and the decoding start subsample, and the difference value of the POC between the current subsample and the normally decoded subsample) may be values with a positive or negative sign. For example, in the first information processing device and the second information processing device, the “difference value of the POC from the current subsample” in the first control information and the second control information described above may be a value with a positive or negative sign. Note that, In this case, the difference value (the difference value of the POC between the current subsample and the decoding start subsample) in the first control information is indicated by a negative value, and the difference value (the difference value of the POC between the current subsample and the normally decoded subsample) in the second control information is indicated by a positive value. Of course, these difference values may be indicated by absolute values. In that case, the control is performed on the assumption that the decoding start subsample corresponding to the first control information is a subsample ahead of the current subsample (a subsample with a smaller POC), and the normally decoded subsample corresponding to the second control information is a subsample behind the current subsample (a subsample with a larger POC).

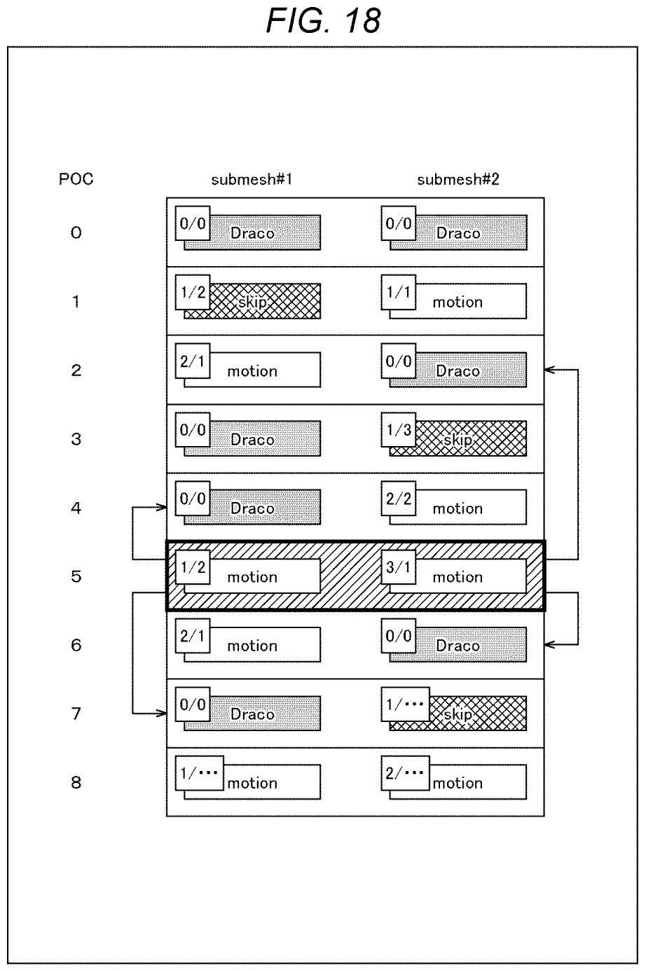

For example, as illustrated in FIG. 18, the random access metadata corresponding to each subsample may include the first control information specifying a decoding start subsample for normally decoding the subsample and the second control information specifying a subsample that is normally decoded in a case where decoding is started from the subsample. In FIG. 18, the numbers in the square attached to the left side of each subsample indicates the “difference value (absolute value) of the POC between the current subsample and the decoding start subsample/difference value (absolute value) of the POC between the current subsample and the normally decoded subsample”.

For example, the subsample corresponding to the submesh #1 of POC5 is given “1” as the difference value of the POC between the current subsample and the decoding start subsample, and is given “2” as the difference value of the POC between the current subsample and the normally decoded subsample. That is, the subsample corresponding to the submesh #1 of POC4 is specified as a decoding start subsample, and the subsample corresponding to the submesh #1 of POC7 is specified as a normally decoded subsample.

Furthermore, the subsample corresponding to the submesh #2 of POC5 is given “3” as the difference value of the POC between the current subsample and the decoding start subsample, and is given “1” as the difference value of the POC between the current subsample and the normally decoded subsample. That is, the subsample corresponding to the submesh #2 of POC2 is specified as a decoding start subsample, and the subsample corresponding to the submesh #2 of POC6 is specified as a normally decoded subsample.

Therefore, in this case, by starting decoding from the subsample of POC4 for the submesh #1 and starting decoding from the subsample of POC2 for the submesh #2, the sample of POC5 can be normally decoded. Furthermore, by starting decoding from the sample of POC5, the submesh #1 can be normally decoded from the subsample of POC7 and the submesh #2 can be normally decoded from the subsample of POC6.

Similarly, for other samples, a decoding start subsample for normally decoding the subsample and a normally decoded subsample that is normally decoded in a case where decoding is started from the subsample are specified as the random access metadata.

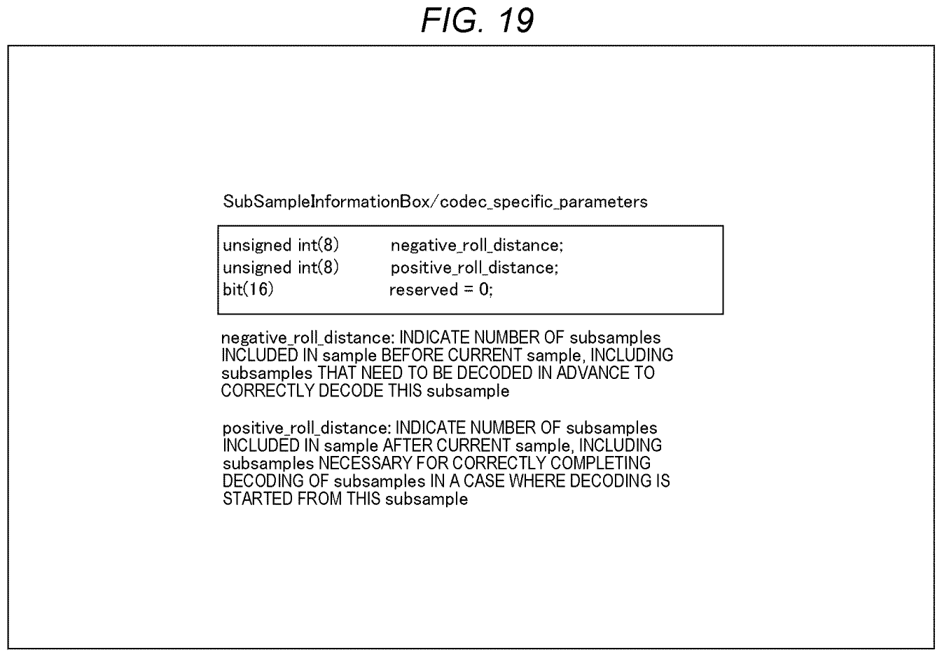

The random access metadata may be stored in the subsample information box, for example, as illustrated in FIG. 19. For example, the random access metadata may be set as the codec specific parameter in the subsample information box. For example, the random access metadata may include the codec specific parameter “negative_roll_distance” and “positive_roll_distance” defined in the subsample information box. The parameter “negative_roll_distance” indicates the number of subsamples included in the sample before the current subsample, including subsamples that need to be decoded in advance to correctly decode this subsample. That is, the parameter “negative_roll_distance” indicates the difference value of the POC between the current subsample and the decoding start subsample. Furthermore, the parameter “positive_roll_distance” indicates the number of subsamples included in the sample after the current sample including the subsamples necessary for correctly completing decoding of subsamples in a case where decoding is started from this subsample. That is, the parameter “positive_roll_distance” indicates the difference value of the POC between the current subsample and the normally decoded subsample.

By controlling random access in this manner, the first information processing device and the second information processing device can obtain effects similar to the case of applying the method 1-3. Furthermore, by controlling random access for each subsample, decoding of unnecessary subsamples can be further reduced as compared with a case where random access reproduction is controlled for each sample. For example, decoding of unnecessary subsamples with the coding type of “I (intra coding)” can be omitted, or decoding of subsamples with the coding type of “P (inter coding)” the reference destination subsample (a subsample with the coding type of “I (intra coding)”) of which is not decoded,, can be omitted. Therefore, an increase in load of the decoding processing can be suppressed. Moreover, such control can be performed on the basis of the random access metadata. That is, such control can be easily realized without requiring parsing of the bit stream.

### <Other Application Examples>

The present technology is not limited to V-DMC, and can be applied to any coding scheme. Furthermore, the present technology is not limited to a base mesh, and can be applied to any mesh data. For example, the present technology may be applied to a file container that stores a bit stream obtained by encoding an original mesh by using a coding scheme in which a mesh is encoded without decimation (simplification), such as geometry-based point cloud compression (G-PCC). Note that the mesh data may be generated by converting 3D data other than the mesh data, such as a point cloud or the like.

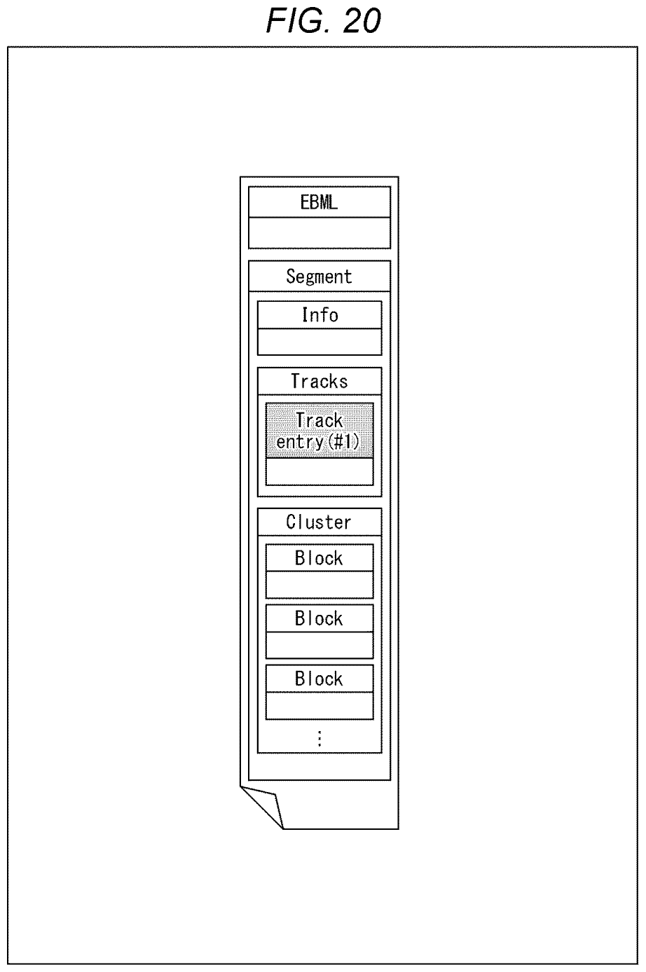

Furthermore, the file container that stores the bit stream is not limited to those conforming to the ISOBMFF, and may have any specification. For example, in the first information processing device and the second information processing device, the content file may be a Matroska media container. FIG. 20 is a diagram illustrating a main configuration example of the Matroska media container. Of course, the file may be a file of another format. Furthermore, the track configuration of the file container may be any configuration. For example, a multi-track including a plurality of tracks may be used, or a single track including one track may be used.

### <Combination>

Each method described above may be applied in combination with any other method as long as there is no contradiction. Three or more methods may be applied in combination. For example, any two or more of the method 1-1 to the method 1-4 may be applied in combination. Furthermore, the combinable approach may include not only those shown in the table of FIG. 5 as “methods” but also all the elements described above. Furthermore, each method described above may be applied in combination with other methods not described above.

Note that, in the present specification, the description made for the upper method is also applied to the lower method belonging to the method as long as there is no contradiction. For example, in a case where it is described that “the method 1 may be applied”, any one or more of the method 1-1 to the method 1-4 may be applied. Moreover, any one or more of the method 1-4-1 to the method 1-4-4 may be applied.

### 4. First Embodiment

### <File Generation Device>

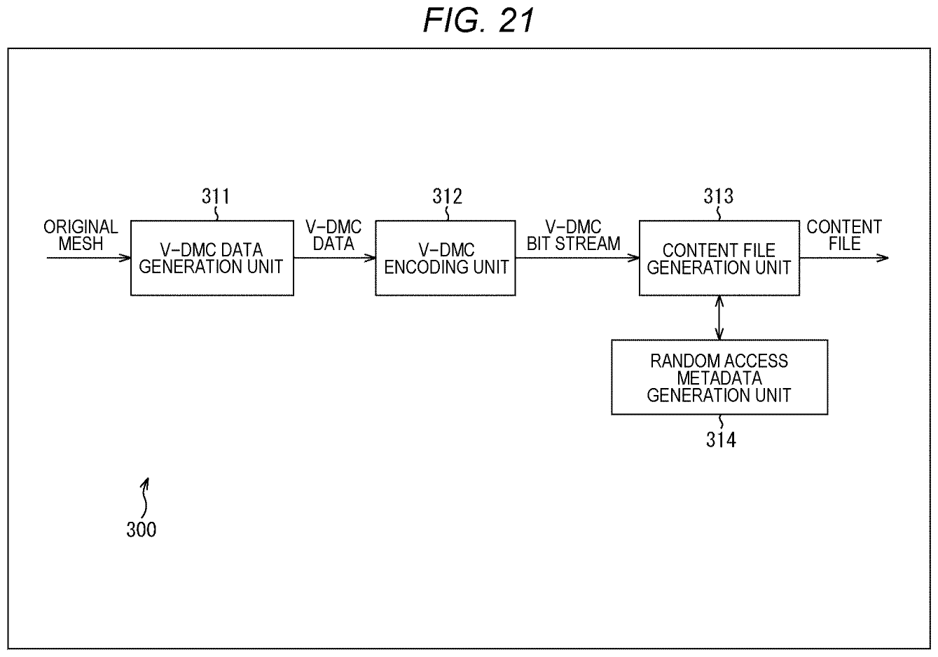

The above-described present technology can be applied to any device. FIG. 21 is a block diagram illustrating an example of a configuration of a file generation device that is an aspect of the information processing device to which the present technology is applied. A file generation device 300 illustrated in FIG. 21 is a device that generates a content file by converting mesh data into V-DMC data, encoding the data, and storing the data in a file container such as the ISOBMFF.

Note that, in FIG. 21, main processing units, data flows, and the like are illustrated, and those illustrated in FIG. 21 are not necessarily all. That is, in the file generation device 300, there may be a processing unit not illustrated as a block in FIG. 21, or there may be processing or a data flow not illustrated as an arrow or the like in FIG. 21.

As illustrated in FIG. 21, the file generation device 300 includes a V-DMC data generation unit 311, a V-DMC encoding unit 312, a content file generation unit 313, and a random access metadata generation unit 314.

The V-DMC data generation unit 311 performs processing related to generation of V-DMC data. For example, the V-DMC data generation unit 311 may acquire mesh data (original mesh) input from the outside of the file generation device 300. The original mesh may include not only geometry (information regarding the positions of the vertices, the connections, and the like) but also an attribute (for example, a texture applied to the face).

The V-DMC data generation unit 311 may convert the original mesh to generate the V-DMC data (base mesh, displacement vector, attribute (texture), and atlas information). Therefore, the V-DMC data generation unit 311 can also be referred to as a conversion unit. For example, the V-DMC data generation unit 311 may generate the base mesh by decimating the geometry of the original mesh. Decimation is processing of reducing the number of faces (the number of polygons) by decimating some vertices (and connections) of a mesh. Therefore, the V-DMC data generation unit 311 can also be referred to as a decimation unit that performs decimation. Furthermore, the V-DMC data generation unit 311 may generate a displacement vector corresponding to the base mesh by subdividing the base mesh. Therefore, the V-DMC data generation unit 311 can also be referred to as a displacement vector generation unit that generates a displacement vector. Furthermore, the V-DMC data generation unit 311 may generate atlas information corresponding to the base mesh, the displacement vector, and the attribute (texture). Therefore, the V-DMC data generation unit 311 can also be referred to as an atlas information generation unit that generates atlas information. The V-DMC data generation unit 311 may supply the generated V-DMC data to the V-DMC encoding unit 312. Therefore, the V-DMC data generation unit 311 can also be referred to as a V-DMC data supply unit that supplies V-DMC data.

The V-DMC encoding unit 312 executes processing related to encoding of the V-DMC data. For example, the V-DMC encoding unit 312 may acquire the V-DMC data supplied from the V-DMC data generation unit 311. Furthermore, the V-DMC encoding unit 312 may encode the acquired V-DMC data. That is, the V-DMC encoding unit 312 may encode each of the atlas information, the base mesh, the displacement vector, and the attribute included in the V-DMC data, and generate the coded data of the atlas information, the coded data of the base mesh, the coded data of the displacement vector, and the coded data of the attribute. The V-DMC encoding unit 312 may set the generated coded data of the atlas information, the generated coded data of the base mesh, the generated coded data of the displacement vector, and the generated coded data of the attribute as respective substreams, and collect (multiplex) the substreams to generate one V-DMC bit stream. Therefore, the V-DMC encoding unit 312 can also be referred to as a V-DMC bit stream generation unit. The V-DMC encoding unit 312 may supply the generated V-DMC bit stream to the content file generation unit 313.

The content file generation unit 313 performs processing related to generation of the content file. For example, the content file generation unit 313 may acquire the V-DMC bit stream supplied from the V-DMC encoding unit 312. Furthermore, the content file generation unit 313 may generate a content file that is a file container for storing a bit stream. The content file may be, for example, a file conforming to the ISOBMFF. The content file generation unit 313 may store the acquired V-DMC bit stream in the content file. Therefore, the content file generation unit 313 can also be referred to as a storage unit that stores the V-DMC bit stream in the content file.

Furthermore, the content file generation unit 313 may supply the V-DMC bit stream to the random access metadata generation unit 314. The content file generation unit 313 may supply a content file storing the V-DMC bit stream to the random access metadata generation unit 314 instead of the V-DMC bit stream.

Furthermore, the content file generation unit 313 may acquire the random access metadata supplied from the random access metadata generation unit 314. The content file generation unit 313 may store the acquired random access metadata in the content file that stores the V-DMC bit stream corresponding to the random access metadata. Therefore, the content file generation unit 313 can also be referred to as a storage unit that stores the random access metadata in the content file.

The content file generation unit 313 may output the generated content file to the outside of the file generation device 300 (for example, a distribution server, a reproduction device, or the like). Therefore, the content file generation unit 313 can also be referred to as a content file supply unit (providing unit).

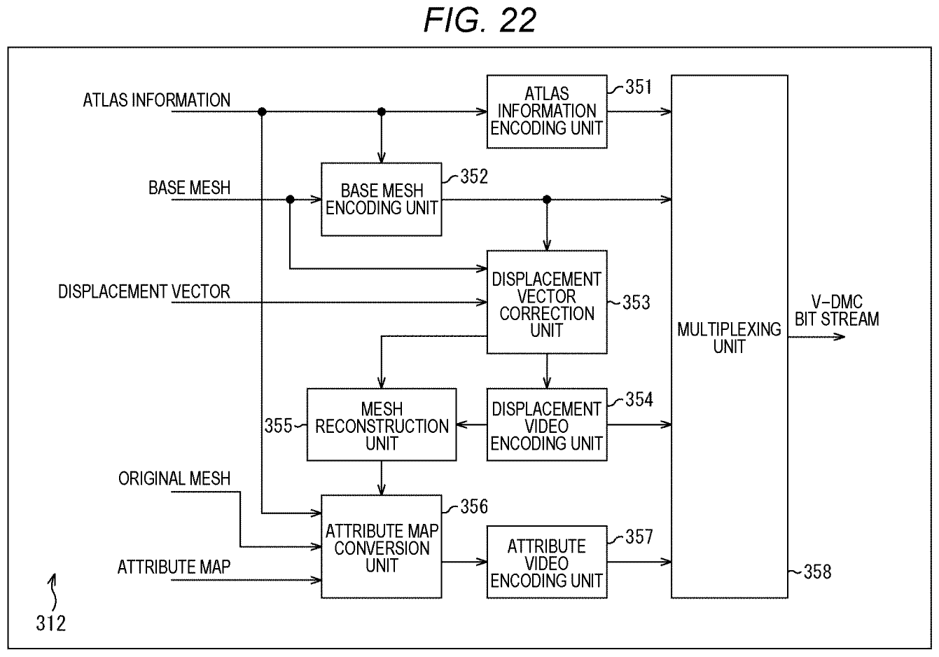

FIG. 22 is a block diagram illustrating a main configuration example of the V-DMC encoding unit 312. Note that, in FIG. 22, main parts of processing units, data flows, and the like are illustrated, and those illustrated in FIG. 22 are not necessarily all. That is, in the V-DMC encoding unit 312, there may be a processing unit not illustrated as a block in FIG. 22, or there may be a processing or data flow not illustrated as an arrow or the like in FIG. 22.

As illustrated in FIG. 22, the V-DMC encoding unit 312 includes an atlas information encoding unit 351, a base mesh encoding unit 352, a displacement vector correction unit 353, a displacement video encoding unit 354, a mesh reconstruction unit 355, an attribute map conversion unit 356, an attribute video encoding unit 357, and a multiplexing unit 358.

The atlas information encoding unit 351 performs processing related to encoding of atlas information. For example, the atlas information encoding unit 351 may acquire the atlas information supplied from the V-DMC data generation unit 311. Furthermore, the atlas information encoding unit 351 may encode the acquired atlas information by a predetermined coding scheme to generate coded data of the atlas information. The atlas information encoding unit 351 may supply the generated coded data of the atlas information to the multiplexing unit 358.

The base mesh encoding unit 352 performs processing related to encoding of the base mesh. For example, the base mesh encoding unit 352 may acquire the base mesh supplied from the V-DMC data generation unit 311. Furthermore, the base mesh encoding unit 352 may quantize the acquired base mesh, encode the quantized base mesh by a predetermined coding scheme (for example, Draco or the like), and generate coded data of the base mesh. At that time, the base mesh encoding unit 352 may encode the base mesh according to the atlas information. The base mesh encoding unit 352 may supply the generated coded data of the base mesh to the displacement vector correction unit 353. Furthermore, the base mesh encoding unit 352 may supply the generated coded data of the base mesh to the multiplexing unit 358.

The displacement vector correction unit 353 performs processing related to correction of the displacement vector. For example, the displacement vector correction unit 353 may acquire the base mesh and the displacement vector supplied from the V-DMC data generation unit 311. Furthermore, the displacement vector correction unit 353 may acquire the coded data of the base mesh supplied from the base mesh encoding unit 352. The displacement vector correction unit 353 may correct the displacement vector on the basis of these pieces of information. For example, the displacement vector correction unit 353 may decode and inversely quantize the acquired coded data of the base mesh, and may restore the base mesh (may generate a restored base mesh). The displacement vector correction unit 353 may subdivide each of the base mesh before encoding and the restored base mesh. The displacement vector correction unit 353 may compare the subdivided base mesh before encoding with the subdivided restored base mesh to obtain coding distortion. The displacement vector correction unit 353 may correct the displacement vector according to the coding distortion. The displacement vector correction unit 353 may supply the corrected displacement vector to the displacement video encoding unit 354. Furthermore, the displacement vector correction unit 353 may supply the subdivided restored base mesh to the mesh reconstruction unit 355.

The displacement video encoding unit 354 performs processing related to encoding of the displacement video. The displacement video is a moving image in which a displacement map is a frame image, the displacement map being a two-dimensional area in which displacement vectors are packed. For example, the displacement video encoding unit 354 may acquire the displacement vector supplied from the displacement vector correction unit 353. Furthermore, the displacement video encoding unit 354 may generate a displacement map by performing wavelet transform on the displacement vector, quantizing the displacement vector, and packing the displacement vector in a two-dimensional area. Furthermore, the displacement video encoding unit 354 may generate a displacement video using the displacement map as a frame image. Furthermore, the displacement video encoding unit 354 may encode the generated displacement video by a predetermined coding scheme for 2D moving images to generate coded data of the displacement video. The displacement video encoding unit 354 may supply the generated coded data of the displacement video to the multiplexing unit 358. Furthermore, the displacement video encoding unit 354 may decode the generated coded data of the displacement video, and may restore the displacement video (may generate a restored displacement video). The displacement video encoding unit 354 may extract the displacement map from the restored displacement video. The displacement video encoding unit 354 may unpack the displacement vector from the displacement map. The displacement video encoding unit 354 may inversely quantize the displacement vector. The displacement video encoding unit 354 may supply the inversely-quantized displacement vector to the mesh reconstruction unit 355.

The mesh reconstruction unit 355 performs processing related to mesh reconstruction. For example, the mesh reconstruction unit 355 may acquire the base mesh (subdivided restored base mesh) supplied from the displacement vector correction unit 353. Furthermore, the mesh reconstruction unit 355 may acquire the displacement vector supplied from the displacement video encoding unit 354. The mesh reconstruction unit 355 may reconstruct the restored mesh using the base mesh and the displacement vector. The mesh reconstruction unit 355 may supply the restored mesh to the attribute map conversion unit 356.

The attribute map conversion unit 356 performs processing related to conversion of the attribute map. For example, the attribute map conversion unit 356 may acquire the restored mesh supplied from the mesh reconstruction unit 355. Furthermore, the attribute map conversion unit 356 may acquire the atlas information supplied from the V-DMC data generation unit 311. The attribute map conversion unit 356 may acquire the original mesh input to the file generation device 300. The attribute map conversion unit 356 may acquire the attribute map supplied from the V-DMC data generation unit 311. The attribute map conversion unit 356 may convert the acquired attribute map on the basis of the acquired other information. For example, the attribute map conversion unit 356 may convert the attribute map so as to correspond to the restored mesh on the basis of the atlas information, the original mesh, and the like. In other words, it can also be said that the attribute map conversion unit 356 generates the attribute map after the conversion. Therefore, the attribute map conversion unit 356 can also be referred to as an attribute map generation unit. The attribute map conversion unit 356 may supply the attribute map after the conversion to the attribute video encoding unit 357.

The attribute video encoding unit 357 performs processing related to encoding of the attribute video. For example, the attribute video encoding unit 357 may acquire the attribute map supplied from the attribute map conversion unit 356. Furthermore, the attribute video encoding unit 357 may generate an attribute video using the acquired attribute map as a frame image. Furthermore, the attribute video encoding unit 357 may encode the generated attribute video by a predetermined coding scheme for 2D moving images to generate coded data of the attribute video. The attribute video encoding unit 357 may supply the generated coded data of the attribute video to the multiplexing unit 358.

The multiplexing unit 358 performs processing related to multiplexing of the coded data (substreams). For example, the multiplexing unit 358 may acquire the coded data of the atlas information supplied from the atlas information encoding unit 351. Furthermore, the multiplexing unit 358 may acquire the coded data of the base mesh supplied from the base mesh encoding unit 352. Furthermore, the multiplexing unit 358 may acquire the coded data of the displacement video supplied from the displacement video encoding unit 354. Furthermore, the multiplexing unit 358 may acquire the coded data of the attribute video supplied from the attribute video encoding unit 357. The multiplexing unit 358 may multiplex those coded data as a substream to generate a V-DMC bit stream. Therefore, the multiplexing unit 358 can also be referred to as a bit stream generation unit. The multiplexing unit 358 may supply the generated V-DMC bit stream to the content file generation unit 313.

The file generation device 300 having the above configuration may be the first information processing device, and the various methods (the present technology) described above in <3. Transmission and control of random access metadata> may be applied.

For example, in the file generation device 300 (first information processing device), the random access metadata generation unit 314 may generate random access metadata for performing random access on the mesh data on the basis of a current sample that is an inter-mesh sample, and the content file generation unit 313 may store the random access metadata in a content file that stores the mesh data.

As a result, the file generation device 300 can obtain an effect similar to that described above in <3. Transmission and control of random access metadata>. That is, in a case where the bit stream obtained by encoding the mesh data is stored in the file container, the file generation device 300 can suppress a reduction in random accessibility while suppressing a reduction in coding efficiency.

### <Flow of File Generation Processing>

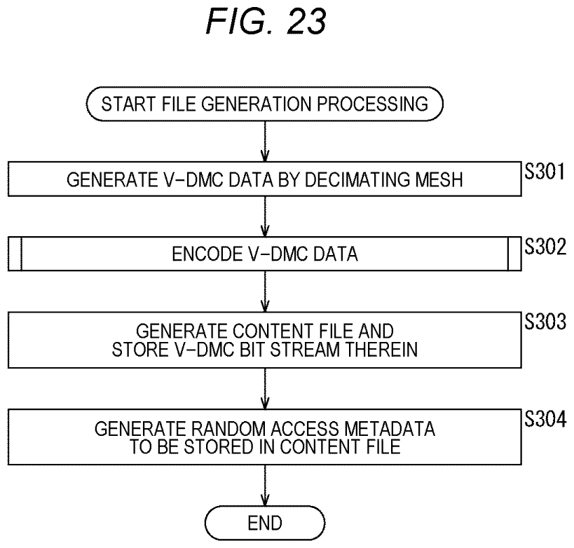

Next, an example of a flow of file generation processing executed by the file generation device 300 will be described with reference to a flowchart of FIG. 23.

When the file generation processing is started, the V-DMC data generation unit 311 of the file generation device 300 generates V-DMC data by decimating the mesh data or the like in step S301.

In step S302, the V-DMC encoding unit 312 executes V-DMC data encoding processing, and encodes the V-DMC data to generate a V-DMC bit stream.

In step S303, the content file generation unit 313 generates a content file and stores the V-DMC bit stream in the content file.

In step S304, the random access metadata generation unit 314 generates random access metadata for performing random access on the mesh data on the basis of the current sample, which is the inter-mesh sample. Furthermore, the content file generation unit 313 stores the random access metadata in the content file that stores the mesh data.

When the processing of step S304 ends, the file generation processing ends.

### <Flow of V-DMC Encoding Processing>

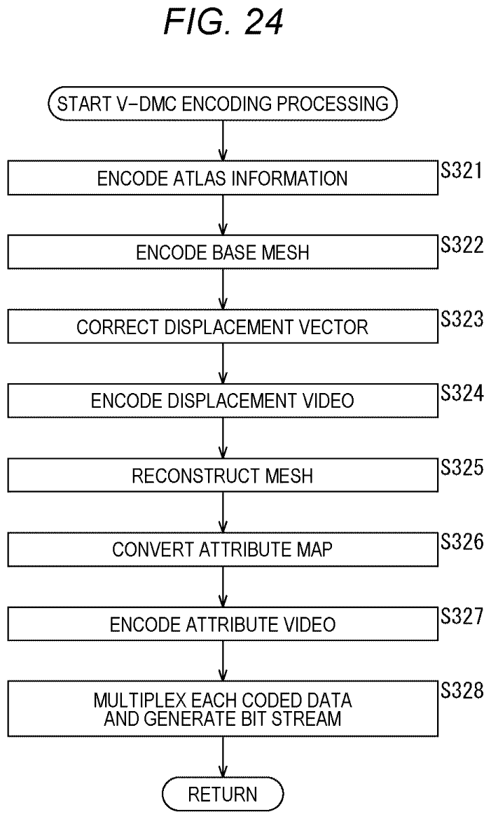

Next, an example of a flow of V-DMC encoding processing executed in step S302 of FIG. 23 will be described with reference to a flowchart of FIG. 24.

When the V-DMC encoding processing is started, the atlas information encoding unit 351 encodes the atlas information and generates coded data of the atlas information in step S321.

In step S322, the base mesh encoding unit 352 encodes the base mesh and generates coded data of the base mesh.

In step S323, the displacement vector correction unit 353 corrects the displacement vector.

In step S324, the displacement video encoding unit 354 encodes the displacement video having the displacement map in which the corrected displacement vectors are packed as a frame image, and generates coded data of the displacement video.

In step S325, the mesh reconstruction unit 355 reconstructs the mesh (generates a restored mesh).

In step S326, the attribute map conversion unit 356 converts the attribute map.

In step S327, the attribute video encoding unit 357 encodes the attribute video having the attribute map as a frame image, and generates coded data of the attribute video.

In step S328, the multiplexing unit 358 multiplexes each of the coded data of the atlas information, the coded data of the bit stream, the coded data of the displacement video, and the coded data of the attribute video as a substream, and generates a V-DMC bit stream.

When the processing in step S328 ends, the V-DMC encoding processing ends, and the process returns to FIG. 23.

By executing each processing as described above, the file generation device 300 can obtain an effect similar to that described above in <3. Transmission and control of random access metadata>. That is, in a case where the bit stream obtained by encoding the mesh data is stored in the file container, the file generation device 300 can suppress a reduction in random accessibility while suppressing a reduction in coding efficiency.

### 5. Second Embodiment

### <Reproduction Device>

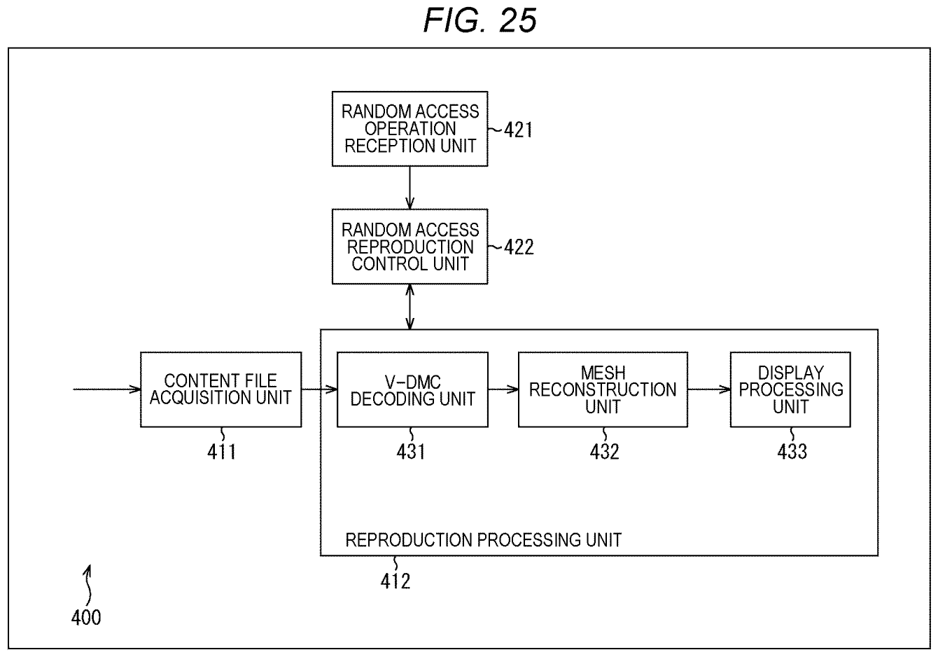

The above-described present technology can be applied to any device. FIG. 25 is a block diagram illustrating an example of a configuration of a reproduction device that is an aspect of the information processing device to which the present technology is applied. A reproduction device 400 illustrated in FIG. 25 is a reproduction device that performs reproduction processing of mesh data (V-DMC data). For example, the reproduction device 400 acquires the content file generated by the file generation device 300, decodes the V-DMC bit stream stored in the content file, and reproduces the V-DMC data. That is, the reproduction device 400 reconstructs the mesh using the V-DMC data, performs rendering to generate a display image, and displays the display image.

Note that, in FIG. 25, main processing units, data flows, and the like are illustrated, and those illustrated in FIG. 25 are not necessarily all. That is, in the reproduction device 400, there may be a processing unit not illustrated as a block in FIG. 25, or there may be processing or a data flow not illustrated as an arrow or the like in FIG. 25.

As illustrated in FIG. 25, the reproduction device 400 includes a content file acquisition unit 411, a reproduction processing unit 412, a random access operation reception unit 421, and a random access reproduction control unit 422. Furthermore, the reproduction processing unit 412 includes a V-DMC decoding unit 431, a mesh reconstruction unit 432, and a display processing unit 433.

The content file acquisition unit 411 performs processing related to acquisition of the content file. For example, the content file acquisition unit 411 may acquire the content file. The content file may be generated by applying the present technology with the file generation device 300, for example. Furthermore, the content file acquisition unit 411 may extract the V-DMC bit stream stored in the content file from the acquired content file, and supply the V-DMC bit stream to (the V-DMC decoding unit 431 of) the reproduction processing unit 412. At that time, the content file acquisition unit 411 may extract and supply the V-DMC bit stream under the control of the reproduction processing unit 412. Furthermore, at that time, the content file acquisition unit 411 may perform random access to the V-DMC bit stream stored in the content file under the control of the random access reproduction control unit 422 (via the reproduction processing unit 412).

The reproduction processing unit 412 executes processing related to reproduction of the mesh data. For example, the reproduction processing unit 412 may control the content file acquisition unit 411 to extract and acquire the V-DMC bit stream from the content file. At that time, the reproduction processing unit 412 may perform control to perform random access under the control of the random access reproduction control unit 422. Furthermore, the reproduction processing unit 412 may decode the acquired V-DMC bit stream, reconstruct the mesh, render the mesh, and display the display image.

The random access operation reception unit 421 performs processing related to reception of the random access operation. The random access operation indicates an operation (instruction) related to random access to the V-DMC bit stream stored in the content file. For example, the random access operation may include an instruction regarding the trick reproduction (for example, jumping reproduction, fast-forwarding, rewinding, and the like). For example, the random access operation reception unit 421 may have an input device operated by the user or the like, and receive a random access operation input via the input device. Furthermore, the random access operation reception unit 421 may include an application program interface (API) that receives an instruction supplied from an application or the like, and may receive a random access operation input via the API. This application may perform any processing. The random access operation reception unit 421 may supply the received random access operation to the random access reproduction control unit 422.

The random access reproduction control unit 422 performs processing related to control of random access reproduction. The random access reproduction indicates reproduction processing involving random access of the V-DMC bit stream stored in the content file. The reproduction processing involving random access may include, for example, trick reproduction (for example, jumping reproduction, fast-forwarding, rewinding, and the like). For example, the random access reproduction control unit 422 may control the reproduction processing unit 412 to perform random access reproduction. That is, the random access reproduction control unit 422 may control the reproduction processing unit 412 to randomly access the V-DMC bit stream stored in the content file and start reproduction (jumping reproduction) from a sample in the middle of the sequence. Furthermore, the random access reproduction control unit 422 may control the reproduction processing unit 412 to execute fast-forwarding or rewinding by applying such a reproduction method.

The V-DMC decoding unit 431 of the reproduction processing unit 412 executes processing related to decoding of the V-DMC bit stream. For example, the V-DMC decoding unit 431 may acquire the V-DMC bit stream extracted from the content file in the content file acquisition unit 411. The V-DMC decoding unit 431 may decode the V-DMC bit stream, and may restore the V-DMC data (may generate the restored V-DMC data). The V-DMC decoding unit 431 may supply the V-DMC data restored (restored V-DMC data) to the mesh reconstruction unit 432.

The mesh reconstruction unit 432 executes processing related to reconstruction of the mesh (3D data). For example, the mesh reconstruction unit 432 may acquire the restored V-DMC data supplied from the V-DMC decoding unit 431. The mesh reconstruction unit 432 may convert the restored V-DMC data into mesh data. The mesh reconstruction unit 432 may reconstruct the mesh (restored mesh) using the mesh data. The mesh reconstruction unit 432 may supply the restored mesh (3D data) to the display processing unit 433.

The display processing unit 433 executes processing related to display of the restored mesh. For example, the display processing unit 433 may acquire the restored mesh (3D data) supplied from the mesh reconstruction unit 432. The display processing unit 433 may render the restored mesh and generate a display image for displaying the restored mesh. The display processing unit 433 may include a display device such as a monitor and display a display image using the display device. Therefore, the display processing unit 433 can also be referred to as a display unit. Furthermore, the display processing unit 433 may supply the display image to the outside of the reproduction device 400 (for example, a recording medium, another display device, or the like). Therefore, the display processing unit 433 can also be referred to as an output unit.

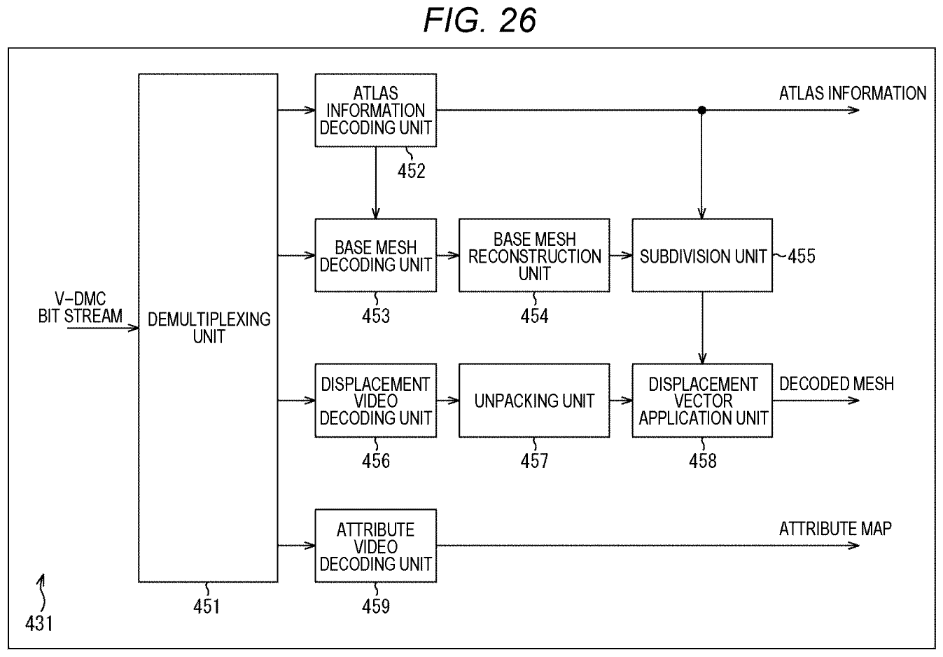

FIG. 26 is a block diagram illustrating a main configuration example of the V-DMC decoding unit 431. Note that FIG. 26 illustrates a main configuration including processing units, data flows, and the like, and the processing units and data flows illustrated in FIG. 26 are not necessarily all. That is, in the V-DMC decoding unit 431, there may be a processing unit not illustrated as a block in FIG. 26, or there may be a processing or data flow not illustrated as an arrow or the like in FIG. 26.

As illustrated in FIG. 26, the V-DMC decoding unit 431 includes a demultiplexing unit 451, an atlas information decoding unit 452, a base mesh decoding unit 453, a base mesh reconstruction unit 454, a subdivision unit 455, a displacement video decoding unit 456, an unpacking unit 457, a displacement vector application unit 458, and an attribute video decoding unit 459.

The demultiplexing unit 451 performs processing related to demultiplexing. For example, the demultiplexing unit 451 may acquire the V-DMC bit stream supplied from the content file acquisition unit 411. Furthermore, the demultiplexing unit 451 may demultiplex the acquired V-DMC bit stream, and extract the coded data of the atlas information, the coded data of the base mesh, the coded data of the displacement video, and the coded data of the attribute video. Therefore, the demultiplexing unit 451 can also be referred to as an acquisition unit of various types of information included in the V-DMC bit stream. The demultiplexing unit 451 may supply the extracted coded data of the atlas information to the atlas information decoding unit 452. Furthermore, the demultiplexing unit 451 may supply the extracted coded data of the base mesh to the base mesh decoding unit 453. Furthermore, the demultiplexing unit 451 may supply the extracted coded data of the displacement video to the displacement video decoding unit 456. Furthermore, the demultiplexing unit 451 may supply the extracted coded data of the attribute video to the attribute video decoding unit 459.

The atlas information decoding unit 452 performs processing related to decoding of the coded data of the atlas information. For example, the atlas information decoding unit 452 may acquire the coded data of the atlas information supplied from the demultiplexing unit 451. Furthermore, the atlas information decoding unit 452 may decode the acquired coded data of the atlas information, and may generate (restore) the atlas information. The atlas information decoding unit 452 may supply the atlas information to the base mesh decoding unit 453 and the subdivision unit 455. Furthermore, the atlas information decoding unit 452 may supply the atlas information to the mesh reconstruction unit 432 as restored V-DMC data.

The base mesh decoding unit 453 performs processing related to decoding of the coded data of the base mesh. For example, the base mesh decoding unit 453 may acquire the coded data of the base mesh supplied from the demultiplexing unit 451. Furthermore, the base mesh decoding unit 453 may decode the acquired coded data of the base mesh by a predetermined decoding scheme (for example, Draco or the like), and generate (restore) information (for example, a vertex list, a triangle list, or the like) regarding the base mesh. For example, the base mesh decoding unit 453 may decode the coded data of the base mesh according to the atlas information supplied from the atlas information decoding unit 452. The base mesh decoding unit 453 may supply the atlas information and the information regarding the base mesh to the base mesh reconstruction unit 454.

The base mesh reconstruction unit 454 executes processing related to reconstruction of the base mesh. For example, the base mesh reconstruction unit 454 may acquire the atlas information and the information regarding the base mesh supplied from the base mesh decoding unit 453. The base mesh reconstruction unit 454 may reconstruct the base mesh (may generate a restored base mesh) using the acquired atlas information and information regarding the base mesh. The base mesh reconstruction unit 454 may supply the base mesh (restored base mesh) to the subdivision unit 455.

The subdivision unit 455 performs processing related to subdivision of the triangles of the base mesh (restored base mesh). For example, the subdivision unit 455 may acquire the base mesh (restored base mesh) supplied from the base mesh reconstruction unit 454. Furthermore, the subdivision unit 455 may acquire the atlas information supplied from the atlas information decoding unit 452. The subdivision unit 455 may subdivide the triangles of the base mesh (restored base mesh) on the basis of the atlas information, and generate division points. The subdivision unit 455 may supply the subdivided base mesh (subdivided restored base mesh) to the displacement vector application unit 458.

The displacement video decoding unit 456 executes processing related to decoding of the coded data of the displacement video. For example, the displacement video decoding unit 456 may acquire the coded data of the displacement video supplied from the demultiplexing unit 451. Furthermore, the displacement video decoding unit 456 may decode the coded data of the displacement video by a predetermined decoding scheme for 2D moving images, and generate (restore) the displacement video. The displacement video decoding unit 456 may supply the generated displacement video to the unpacking unit 457.

The unpacking unit 457 executes processing related to unpacking of the displacement vector. For example, the unpacking unit 457 may acquire the displacement video supplied from the displacement video decoding unit 456. Furthermore, the unpacking unit 457 may unpack the displacement map, which is a frame image of the displacement video, and extract a displacement vector. The unpacking unit 457 may supply the displacement vector to the displacement vector application unit 458.

The displacement vector application unit 458 performs processing related to application of the displacement vector to the subdivided base mesh (subdivided restored base mesh). For example, the displacement vector application unit 458 may acquire the subdivided base mesh (subdivided restored base mesh) supplied from the subdivision unit 455. Furthermore, the displacement vector application unit 458 may acquire the displacement vector supplied from the unpacking unit 457. Furthermore, the displacement vector application unit 458 may apply the displacement vector to vertices of the subdivided base mesh (subdivided restored base mesh). That is, the displacement vector application unit 458 reconstructs a mesh (geometry) corresponding to the original mesh. In the present specification, the mesh (geometry) corresponding to the original mesh is also referred to as a decoded mesh. The displacement vector application unit 458 may supply the generated decoded mesh as restored V-DMC data to the mesh reconstruction unit 432.

The attribute video decoding unit 459 executes processing related to decoding of the coded data of the attribute video. For example, the attribute video decoding unit 459 may acquire the coded data of the attribute video supplied from the demultiplexing unit 451. Furthermore, the attribute video decoding unit 459 may decode the coded data of the attribute video by a predetermined decoding scheme for 2D moving images, and generate (restore) the attribute video. The attribute video decoding unit 459 may supply the attribute map, which is a frame image of the attribute video, to the mesh reconstruction unit 432 as restored V-DMC data.

The reproduction device 400 having the above configuration may be the second information processing device described above, and the various methods (the present technology) described above in <3. Transmission and control of random access metadata> may be applied.

For example, in the reproduction device 400 (second information processing device), the random access reproduction control unit 422 may control random access on the basis of random access metadata for performing random access on the basis of a current sample that is an inter-mesh sample, the random access metadata being stored in a content file that stores the mesh data, and the reproduction processing unit 412 may start reproduction of the mesh data by the random access.

That is, the random access reproduction control unit 422 may perform control related to the random access reproduction by the reproduction processing unit 412 on the basis of the random access metadata stored in the content file. For example, the random access reproduction control unit 422 may refer to the random access metadata stored in the content file via the reproduction processing unit 412, and control the random access reproduction by the reproduction processing unit 412 on the basis of the random access metadata.

As a result, the reproduction device 400 can obtain an effect similar to that described above in <3. Transmission and control of random access metadata>. That is, in a case where the bit stream obtained by encoding the mesh data is stored in the file container, the reproduction device 400 can suppress a reduction in random accessibility while suppressing a reduction in coding efficiency.

Note that the random access reproduction control unit 422 may select whether to start decoding of the mesh data, on the basis of the control information (first control information) specifying the sample from which decoding is started, from the sample specified by the control information or whether to start decoding of the mesh data from the current sample on the basis of the control information specifying the sample that is normally decoded (second control information).

Such a selection may be performed according to any information such as an operation mode of the reproduction device 400, a load state, the random access metadata, and the like. For example, the random access reproduction control unit 422 may control random access by using the control information specified by the user, an application, or the like. This specification may be supplied from the random access operation reception unit 421, for example. Furthermore, in a case where the current load of the reproduction device 400 is larger than predetermined criteria, the random access reproduction control unit 422 may prioritize low latency, and otherwise may prioritize image integrity. Furthermore, in a case where the normally decoded sample is closer to the current sample than the decoding start sample, the random access reproduction control unit 422 may control random access on the basis of the control information (second control information) specifying a sample that is normally decoded, and otherwise, control random access on the basis of the control information (first control information) specifying a sample from which decoding is started. Of course, other selection methods may be applied.

With this control, the reproduction device 400 can realize normal decoding and displaying from the current sample, and can realize normal decoding and displaying from the normally decoded sample. That is, the reproduction device 400 can prioritize image integrity or can prioritize low latency. Furthermore, the reproduction device 400 can also select a more appropriate control method according to the situation.

### <Flow of Reproduction Processing>

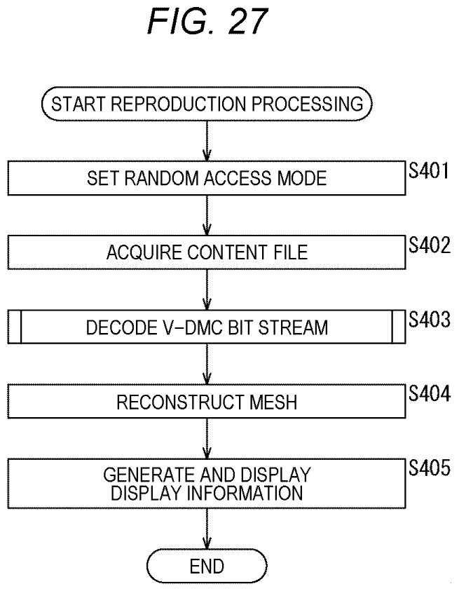

Next, an example of a flow of the reproduction processing executed by the reproduction device 400 will be described with reference to a flowchart of FIG. 27.

When the reproduction processing is started, the random access reproduction control unit 422 of the reproduction device 400 sets the random access mode, which is the operation mode related to control of the random access, in step S401. For example, the random access reproduction control unit 422 selects whether to start decoding of the mesh data, on the basis of the control information (first control information) specifying the sample from which decoding is started, from the sample specified by the control information or whether to start decoding of the mesh data from the current sample on the basis of the control information specifying the sample that is normally decoded (second control information).

In step S402, the content file acquisition unit 411 acquires the content file, and extracts the V-DMC bit stream stored in the content file.

In step S403, the V-DMC decoding unit 431 executes V-DMC decoding processing, decodes the V-DMC bit stream, and restores V-DMC data (generates restored V-DMC data).

In step S404, the mesh reconstruction unit 432 converts the restored V-DMC data into mesh data, and reconstructs the mesh (restored mesh) using the mesh data.

In step S405, the display processing unit 433 renders the restored mesh to generate display information, and display the display information.

When the processing in step S405 ends, the reproduction processing ends.

### <Flow of V-DMC Decoding Processing>

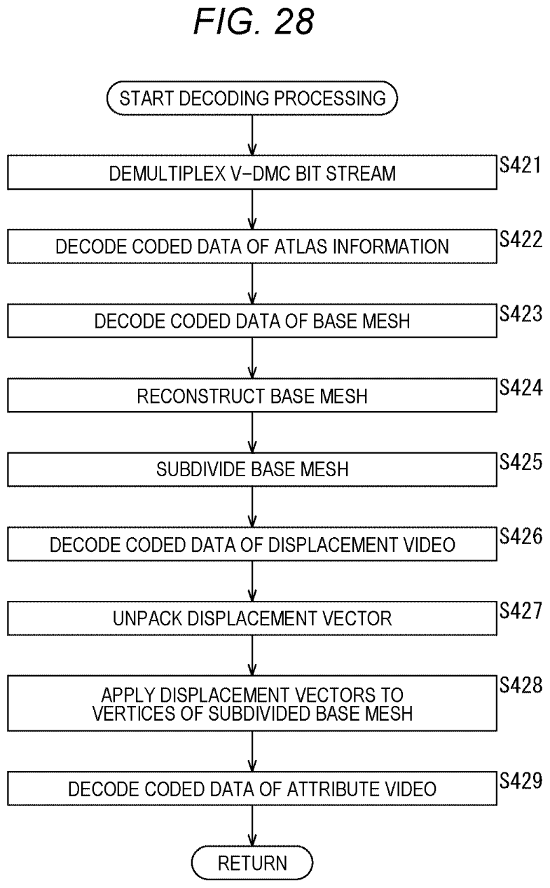

An example of a flow of the V-DMC decoding processing executed in step S403 of FIG. 27 will be described with reference to a flowchart of FIG. 28.

When the V-DMC decoding processing is started, the demultiplexing unit 451 demultiplexes the V-DMC bit stream in step S421.

In step S422, the atlas information decoding unit 452 decodes the coded data of the atlas information as atlas information, and generates (restores) atlas information.

In step S423, the base mesh decoding unit 453 decodes the coded data of the base mesh according to the atlas information, and generates (restores) information regarding the base mesh.

In step S424, the base mesh reconstruction unit 454 reconstructs the base mesh (generates a restored base mesh) using the atlas information and the information regarding the base mesh.

In step S425, the subdivision unit 455 subdivides the reconstructed base mesh (restored base mesh) and generates division points.

In step S426, the displacement video decoding unit 456 decodes the coded data of the displacement video and generates (restores) the displacement video.

In step S427, the unpacking unit 457 unpacks a displacement map, which is a frame image of the displacement video, and extract the displacement vector.

In step S428, the displacement vector application unit 458 applies the displacement vectors to the vertices of the subdivided restored base mesh and generates a decoded mesh.

In step S429, the attribute video decoding unit 459 decodes the coded data of the attribute video and generates (restores) the attribute video. The atlas information generated (restored) in step S422, the decoded mesh generated in step S428, and the attribute video generated (restored) in step S429 are supplied to the mesh reconstruction unit 432 as the restored V-DMC data.

When the processing of step S429 ends, the V-DMC decoding processing ends, and the process returns to FIG. 27.

### <Flow of Random Access Reproduction Processing>

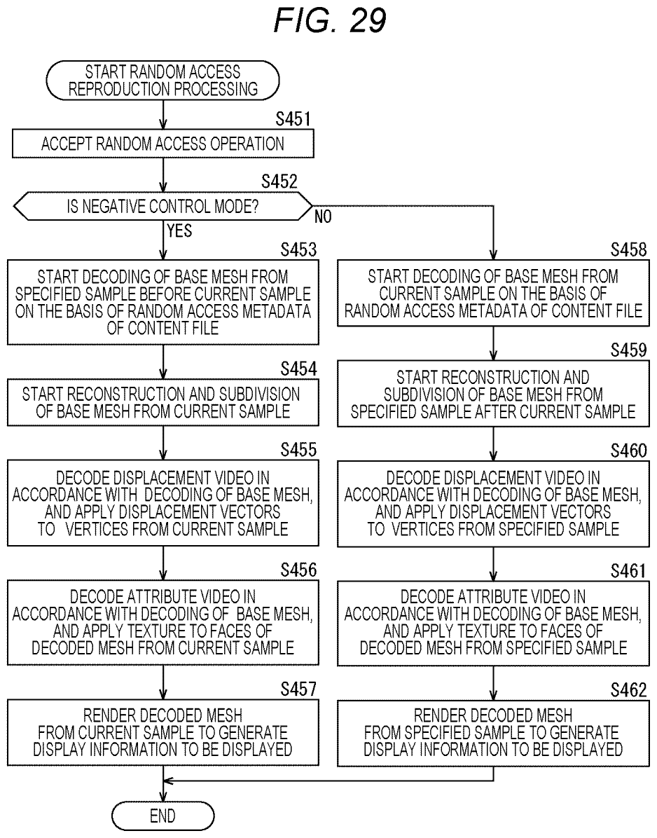

Next, an example of a flow of random access reproduction processing of randomly accessing and reproducing the V-DMC bit stream stored in the content file will be described with reference to a flowchart of FIG. 29.

When the random access reproduction processing is started, the random access operation reception unit 421 receives a random access operation in step S451.

In step S452, the random access reproduction control unit 422 determines in step S401 (FIG. 27) whether a negative control mode or a positive control mode is set as the random access mode. The negative control mode is a mode in which decoding of the mesh data is started, on the basis of the control information (first control information) specifying a sample from which the decoding is started, from the sample specified by the control information. The positive control mode is a mode in which decoding of the mesh data is started from a current sample on the basis of the control information (second control information) specifying a sample that is normally decoded.

In a case where it is determined that the negative control mode is set, the process proceeds to step S453.

In step S453, the random access reproduction control unit 422 randomly accesses the specified sample before the current sample on the basis of the random access metadata of the content file. The reproduction processing unit 412 controls the content file acquisition unit 411 according to the control, and starts extraction from the specified sample. That is, the V-DMC decoding unit 431 starts decoding of the base mesh from the specified sample.

In step S454, under the control of the random access reproduction control unit 422, the V-DMC decoding unit 431 starts reconstruction and subdivision of the base mesh from the current sample.

In step S455, under the control of the random access reproduction control unit 422, the V-DMC decoding unit 431 decodes the displacement video in accordance with the decoding of the base mesh, and applies the displacement vectors to the vertices from the current sample.

In step S456, under the control of the random access reproduction control unit 422, the V-DMC decoding unit 431 decodes the attribute video in accordance with the decoding of the base mesh. Furthermore, under the control of the random access reproduction control unit 422, the mesh reconstruction unit 432 applies the texture to the faces of the decoded mesh from the current sample.

In step S457, the display processing unit 433 renders the decoded mesh from the current sample to generate display information, and display the display information. When the processing of step S457 ends, the random access reproduction processing ends.

Furthermore, in a case where it is determined in step S452 that the positive control mode is set, the process proceeds to step S458.

In step S458, the random access reproduction control unit 422 randomly accesses the current sample on the basis of the random access metadata of the content file. The reproduction processing unit 412 controls the content file acquisition unit 411 according to the control, and starts extraction from the current sample. That is, the V-DMC decoding unit 431 starts decoding of the base mesh from the current sample.

In step S459, under the control of the random access reproduction control unit 422, the V-DMC decoding unit 431 starts reconstruction and subdivision of the base mesh from the specified sample after the current sample.

In step S460, under the control of the random access reproduction control unit 422, the V-DMC decoding unit 431 decodes the displacement video in accordance with the decoding of the base mesh, and applies the displacement vector to the vertices from the specified sample.

In step S461, under the control of the random access reproduction control unit 422, the V-DMC decoding unit 431 decodes the attribute video in accordance with the decoding of the base mesh. Furthermore, under the control of the random access reproduction control unit 422, the mesh reconstruction unit 432 applies the texture to the faces of the decoded mesh from the specified sample.

In step S462, the display processing unit 433 renders the decoded mesh from the specified sample to generate display information, and display the display information. When the processing of step S462 ends, the random access reproduction processing ends.

That is, the random access reproduction control unit 422 controls random access on the basis of the random access metadata for performing the random access on the basis of the current sample that is an inter-mesh sample, the random access metadata being stored in a content file that stores mesh data. Then, the reproduction processing unit 412 starts reproduction of the mesh data by the random access.

By executing each processing as described above, the reproduction device 400 can obtain an effect similar to that described above in <3. Transmission and control of random access metadata>. That is, in a case where the bit stream obtained by encoding the mesh data is stored in the file container, the reproduction device 400 can suppress a reduction in random accessibility while suppressing a reduction in coding efficiency.

### <6. Supplementary Note

### <Computer>

The above-described series of processing can be executed by hardware or software. In a case where the series of processing is executed by software, a program included in the software is installed in a computer. Here, the computer includes a computer incorporated in dedicated hardware, a general-purpose personal computer capable of executing various functions by installing various programs, and the like, for example.

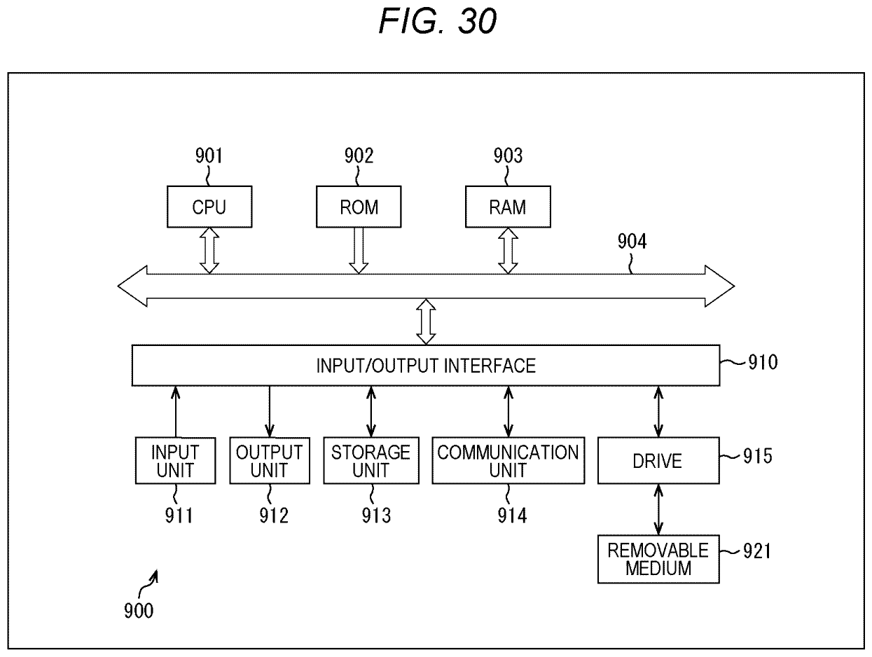

FIG. 30 is a block diagram illustrating a configuration example of hardware of a computer that executes the above-described series of processing by a program.

In a computer 900 illustrated in FIG. 30, a central processing unit (CPU) 901, a read only memory (ROM) 902, and a random access memory (RAM) 903 are mutually connected via a bus 904.

Furthermore, an input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a nonvolatile memory and the like. The communication unit 914 includes, for example, a network interface. The drive 915 drives a removable medium 921 such as a magnetic disk, an optical disk, a magneto-optical disk, or a semiconductor memory.

In the computer configured as described above, for example, the CPU 901 loads a program stored in the storage unit 913 into the RAM 903 via the input/output interface 910 and the bus 904 and executes the program, whereby the above-described series of processing is performed. The RAM 903 also appropriately stores data and the like necessary for the CPU 901 to execute various types of processing.

A program executed by the computer can be applied by being recorded on the removable medium 921 as a package medium, or the like, for example. In this case, the program can be installed in the storage unit 913 via the input/output interface 910 by attaching the removable medium 921 to the drive 915.

Furthermore, the program can also be provided via a wired or wireless transmission medium such as a local area network, the Internet, or digital satellite broadcasting. In this case, the program can be received by the communication unit 914 and installed in the storage unit 913.

In addition, this program can be installed in the ROM 902 or the storage unit 913 in advance.

### <Object to Which Present Technology Is Applicable>

The present technology can be applied to any encoding/decoding scheme.

Furthermore, the present technology can be applied to any configuration. For example, the present technology can be applied to various electronic devices.

Furthermore, for example, the present technology can also be implemented as a partial configuration of a device, such as a processor (for example, a video processor) as a system large scale integration (LSI) or the like, a module (for example, a video module) using a plurality of processors or the like, a unit (for example, a video unit) using a plurality of modules or the like, or a set (for example, a video set) or the like obtained by further adding other functions to the unit.

Furthermore, for example, the present technology can also be applied to a network system including a plurality of devices. For example, the present technology may be implemented as cloud computing shared and processed in cooperation by a plurality of devices via a network. For example, the present technology may be implemented in a cloud service that provides a service related to an image (moving image) to any terminal such as a computer, an audio visual (AV) device, a portable information processing terminal, or an Internet of Things (IoT) device.

Note that, in the present specification, a system means a set of a plurality of components (devices, modules (parts) and the like), and it does not matter whether or not all the components are in the same housing. Therefore, a plurality of devices stored in different housings and connected via a network and one device in which a plurality of modules is stored in one housing are both systems.

### <Field and Application to Which Present Technology is Applicable>

The system, device, processing unit and the like to which the present technology is applied can be used in any field such as traffic, medical care, crime prevention, agriculture, livestock industry, mining, beauty care, factory, home appliance, weather, and natural surveillance, for example. Furthermore, application thereof is also arbitrary.

For example, the present technology can be applied to systems and devices used for providing content for appreciation and the like. Furthermore, for example, the present technology can also be applied to systems and devices used for traffic, such as traffic condition management and automated driving control. Moreover, for example, the present technology can also be applied to systems and devices used for security. Furthermore, for example, the present technology can be applied to systems and devices used for automatic control of a machine and the like. Moreover, for example, the present technology can also be applied to systems and devices provided for use in agriculture and livestock industry. Furthermore, the present technology can also be applied to systems and devices that monitor, for example, the status of nature such as volcanos, forests, and the ocean, wildlife and the like. Moreover, for example, the present technology can also be applied to systems and devices used for sports.

### <Others>

Note that, in the present specification, a “flag” is information for identifying a plurality of states, and includes not only information used for identifying two states of true (1) and false (0) but also information capable of identifying three or more states. Therefore, a value that can be taken by the “flag” may be, for example, a binary of 1/0 or a ternary or more. That is, the number of bits forming this “flag” is any number, and may be one bit or a plurality of bits. Furthermore, identification information (including the flag) is assumed to include not only identification information thereof in a bit stream but also difference information of the identification information with respect to certain reference information in the bit stream, and thus, in the present specification, the “flag” and “identification information” include not only the information thereof but also the difference information with respect to the reference information.

Furthermore, various types of information (such as metadata) regarding coded data (bit stream) may be transmitted or recorded in any form as long as the information is associated with the coded data. Here, the term “associate” means, for example, that one data can be used (linked) when the other data is processed. That is, the data associated with each other may be collected as one data or may be made individual data. For example, information associated with the coded data (image) may be transmitted on a transmission path different from that of the coded data (image). Furthermore, for example, the information associated with the coded data (image) may be recorded in a recording medium different from that of the coded data (image) (or another recording area of the same recording medium). Note that, this “association” may be of not entire data but a part of data. For example, an image and information corresponding to the image may be associated with each other in any unit such as a plurality of frames, one frame, or a part within a frame.

Note that, in the present specification, terms such as “combine”, “multiplex”, “add”, “merge”, “include”, “store”, “put in”, “introduce”, and “insert” mean, for example, to combine a plurality of objects into one, such as to combine coded data and metadata into one data, and mean one method of “associating” described above.

Furthermore, the embodiments of the present technology are not limited to the above-described embodiments, and various modifications are possible without departing from the scope of the present technology.

For example, a configuration described as one device (or processing unit) may be divided and configured as a plurality of devices (or processing units). Conversely, configurations described above as a plurality of devices (or processing units) may be collectively configured as one device (or processing unit). Furthermore, a configuration other than the above-described configurations may be added to the configuration of each device (or each processing unit). Moreover, when the configuration and operation as the entire system are substantially the same, a part of the configuration of a certain device (or processing unit) may be included in the configuration of another device (or another processing unit).

Furthermore, for example, the above-described programs may be executed in any device. In this case, the device is only required to have a necessary function (functional block and the like) and obtain necessary information.

Furthermore, for example, each step in one flowchart may be executed by one device, or may be shared and executed by a plurality of devices. Moreover, in a case where a plurality of pieces of processing is included in one step, the plurality of pieces of processing may be executed by one device, or may be shared and executed by a plurality of devices. In other words, a plurality of pieces of processing included in one step can be executed as processing of a plurality of steps. Conversely, the processing described as the plurality of the steps can also be collectively executed as one step.

Furthermore, for example, in a program executed by the computer, processing of steps describing the program may be executed in a time-series order in the order described in the present specification, or may be executed in parallel or individually at a required timing such as when a call is made. That is, as long as there is no contradiction, the processing of each step may be executed in an order different from the above-described order. Moreover, the processing of the steps describing the program may be executed in parallel with processing of another program, or may be executed in combination with processing of the other program.

Furthermore, for example, a plurality of technologies related to the present technology can be implemented independently as a single entity as long as there is no contradiction. Of course, a plurality of arbitrary present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

Note that the present technology can also have the following configurations.
(1) An information processing device including:
a random access metadata generation unit that generates random access metadata for performing random access on mesh data on the basis of a current sample that is an inter-mesh sample; and
a storage unit that stores the random access metadata in a content file that stores the mesh data.
(2) The information processing device according to (1), in which
the random access metadata includes control information specifying a sample from which decoding is started.
(3) the Information Processing Device According to (2), in which
the control information specifies the sample from which decoding is started by a difference value of a picture order count (POC) from the current sample.
(4) The information processing device according to (3), in which
the difference value is a value with a positive or negative sign.
(5) The information processing device according to (3), in which
the difference value is an absolute value.
(6) The information processing device according to (1), in which
the random access metadata includes control information specifying a sample that is normally decoded.
(7) The information processing device according to (6), in which
the control information specifies the sample that is normally decoded by a difference value of a picture order count (POC) from the current sample.
(8) The information processing device according to (7), in which
the difference value is a value with a positive or negative sign.
(9) The information processing device according to (7), in which
the difference value is an absolute value.
(10) The information processing device according to (1), in which
the random access metadata includes first control information specifying a sample from which decoding is started and second control information specifying a sample that is normally decoded.
(11) The information processing device according to (10), in which
the first control information specifies the sample from which decoding is started by a difference value of a picture order count (POC) from the current sample, and
the second control information specifies the sample that is normally decoded by a difference value of the POC from the current sample.
(12) The information processing device according to (11), in which
the difference value is a value with a positive or negative sign.
(13) The information processing device according (1), in which
the content file manages a submesh of the mesh data as a subsample,
the random access metadata generation unit is configured to generate the random access metadata corresponding to the subsample, and
the storage unit is configured to store the random access metadata corresponding to the subsample in the content file.
(14) the information processing device according to (13), in which
the storage unit is configured to store the random access metadata in a subsample information box of the content file.
(15) The information processing device according to (13), in which
the random access metadata includes information indicating a coding type of the submesh corresponding to the subsample.
(16) The information processing device according to (13), in which
the random access metadata includes control information specifying a subsample from which decoding is started.
(17) The information processing device according to (16), in which
the control information specifies the subsample from which decoding is started by a difference value of a picture order count (POC) from a current subsample.
(18) The information processing device according to (17), in which
the difference value is a value with a positive or negative sign.
(19) The information processing device according to (17), in which
the difference value is an absolute value.
(20) The information processing device according to (13), in which
the random access metadata includes control information specifying a subsample that is normally decoded.
(21) the information processing device according to claim (20), in which
the control information specifies the subsample that is normally decoded by a difference value of a picture order count (POC) from a current subsample.
(22) The information processing device according to (21), in which
the difference value is a value with a positive or negative sign.
(23) The information processing device according to (21), in which
the difference value is an absolute value.
(24) The information processing device according to (13), in which
the random access metadata includes first control information specifying a subsample from which decoding is started and second control information specifying a subsample that is normally decoded.
(25) The information processing device according to (24), in which
the first control information specifies the subsample from which decoding is started by a difference value of a picture order count (POC) from a current subsample, and
the second control information specifies the subsample that is normally decoded by a difference value of the POC from the current subsample.
(26) The information processing device according to (25), in which
the difference value is a value with a positive or negative sign.
(27) the information processing device according to (1), in which
the storage unit is configured to store the random access metadata as a parameter of a sample group.
(28) The information processing device according to (1), in which
the random access metadata generation unit is configured to generate the random access metadata corresponding to the inter-mesh sample.
(29) The information processing device according to (1), in which
the mesh data is data of a base mesh having a lower definition than an original mesh, the base mesh being generated by decimating vertices from the original mesh to be encoded including vertices and connections representing a three-dimensional structure of an object.
(30) The information processing device according to (1), in which
the mesh data is data of an original mesh to be encoded including vertices and connections representing a three-dimensional structure of an object.
(31) The information processing device according to (1), in which
the content file is a file container compliant with an International Organization for Standardization base media file format (ISOBMFF).
(32) The information processing device according to (1), in which
the content file is a Matroska media container.
(33) The information processing device according to (1), in which
the storage unit is configured to store the random access metadata in a track that stores the mesh data of the content file.
(34) An information processing method including:
generating random access metadata for performing random access on mesh data on the basis of a current sample that is an inter-mesh sample; and
storing the random access metadata in a content file that stores the mesh data.
(41) An information processing device including:
a random access reproduction control unit that controls random access on the basis of random access metadata for performing the random access on the basis of a current sample that is an inter-mesh sample, the random access metadata being stored in a content file that stores mesh data; and
a reproduction processing unit that starts reproduction of the mesh data by the random access.
(42) The information processing device according to (41), in which
the random access metadata includes control information specifying a sample from which decoding is started, and
the random access reproduction control unit is configured to start decoding of the mesh data from the sample specified by the control information.
(43) The information processing device according to (42), in which
the control information specifies the sample from which decoding is started by a difference value of a picture order count (POC) from the current sample.
(44) The information processing device according to (43), in which
the difference value is a value with a positive or negative sign.
(45) The information processing device according to (43), in which
the difference value is an absolute value.
(46) The information processing device according to (41), in which
the random access metadata includes control information specifying a sample that is normally decoded, and
the random access reproduction control unit is configured to start decoding of the mesh data from the current sample.

### (47) the Information Processing Device According to

(46), in which
the control information specifies the sample that is normally decoded by a difference value of a picture order count (POC) from the current sample.
(48) The information processing device according to (47), in which
the difference value is a value with a positive or negative sign.
(49) The information processing device according to (47), in which
the difference value is an absolute value.
(50) The information processing device according to (41), in which
the random access metadata includes first control information specifying a sample from which decoding is started and second control information specifying a sample that is normally decoded, and
the random access reproduction control unit is configured to select whether to control the random access on the basis of the first control information or to control the random access on the basis of the second control information.
(51) The information processing device according to (50), in which
the first control information specifies the sample from which decoding is started by a difference value of a picture order count (POC) from the current sample, and
the second control information specifies the sample that is normally decoded by a difference value of the POC from the current sample.
(52) The information processing device according to (51), in which
the difference value is a value with a positive or negative sign.
(53) The information processing device according to (41), in which
the content file manages a submesh of the mesh data as a subsample, and stores the random access metadata corresponding to the subsample,
the random access reproduction control unit is configured to control the random access to the subsample on the basis of the random access metadata corresponding to the subsample, and
the reproduction processing unit is configured to start reproduction of the mesh data for each subsample by the random access.
(54) The information processing device according to (53), in which
the content file stores the random access metadata in a subsample information box.
(55) The information processing device according to (53), in which
the random access metadata includes information indicating a coding type of the submesh corresponding to the subsample, and
the random access reproduction control unit is configured to control the random access to the subsample on the basis of the coding type.
(56) The information processing device according to (53), in which
the random access metadata includes control information specifying a subsample from which decoding is started, and
the random access reproduction control unit is configured to start decoding of the mesh data from the subsample specified by the control information.
(57) The information processing device according to (56), in which
the control information specifies the subsample from which decoding is started by a difference value of a picture order count (POC) from the current subsample.
(58) The information processing device according to (57), in which
the difference value is a value with a positive or negative sign.
(59) The information processing device according to (57), in which
the difference value is an absolute value.
(60) The information processing device according to (53), in which
the random access metadata includes control information specifying a subsample that is normally decoded, and
the random access reproduction control unit is configured to start decoding of the mesh data from the current subsample.
(61) The information processing device according to (60), in which
the control information specifies the subsample that is normally decoded by a difference value of a picture order count (POC) from the current subsample.
(62) The information processing device according to (61), in which
the difference value is a value with a positive or negative sign.
(63) the information processing device according to (61), in which
the difference value is an absolute value.
(64) The information processing device according to (53), in which
the random access metadata includes first control information specifying a subsample from which decoding is started and second control information specifying a subsample that is normally decoded, and
the random access reproduction control unit is configured to select whether to control the random access on the basis of the first control information or to control the random access on the basis of the second control information.
(65) the information processing device according to (64), in which
the first control information specifies the subsample from which decoding is started by a difference value of a picture order count (POC) from a current subsample, and
the second control information specifies the subsample that is normally decoded by a difference value of the POC from the current subsample.
(66) The information processing device according to (65), in which
the difference value is a value with a positive or negative sign.
(67) The information processing device according to (41), in which
the content file stores the random access metadata as a parameter of a sample group.
(68) The information processing device according to (41), in which
the random access metadata corresponds to the inter-mesh sample.
(69) the information processing device according to (41), in which
the mesh data is data of a base mesh having a lower definition than an original mesh, the base mesh being generated by decimating vertices from the original mesh to be encoded including vertices and connections representing a three-dimensional structure of an object.
(70) The information processing device according to (41), in which
the mesh data is data of an original mesh to be encoded including vertices and connections representing a three-dimensional structure of an object.
(71) The information processing device according to (41), in which
the content file is a file container compliant with an International Organization for Standardization base media file format (ISOBMFF).
(72) The information processing device according to (41), in which
the content file is a Matroska media container.
(73) The information processing device according to (41), in which
the content file stores the random access metadata in a track that stores the mesh data.
(74) An information processing method including:
controlling random access on the basis of random access metadata for performing the random access on the basis of a current sample that is an inter-mesh sample, the random access metadata being stored in a content file that stores mesh data; and
starting reproduction of the mesh data by the random access.

### REFERENCE SIGNS LIST

300 File generation device
311 V-DMC data generation unit
312 V-DMC encoding unit
313 Content file generation unit
314 Random access metadata generation unit
351 Atlas information encoding unit
352 Base mesh encoding unit
353 Displacement vector correction unit
354 Displacement video encoding unit
355 Mesh reconstruction unit
356 Attribute map conversion unit
357 Attribute video encoding unit, 358 Multiplexing unit
400 Reproduction device
411 Content file acquisition unit
412 Reproduction processing unit
421 Random access operation reception unit
422 Random access reproduction control unit
431 V-DMC decoding unit
432 Mesh reconstruction unit
433 Display processing unit
451 Demultiplexing unit
452 Atlas information decoding unit
453 Base mesh decoding unit
454 Base mesh reconstruction unit
455 Subdivision unit
456 Displacement video decoding unit
457 Unpacking unit
458 Displacement vector application unit
459 Attribute video decoding unit
900 Computer

1. An information processing device comprising:
a random access metadata generation unit that generates random access metadata for performing random access on mesh data on a basis of a current sample that is an inter-mesh sample; and
a storage unit that stores the random access metadata in a content file that stores the mesh data.

2. The information processing device according to claim 1, wherein
the random access metadata includes control information specifying a sample from which decoding is started.

3. The information processing device according to claim 2, wherein
the control information specifies the sample from which decoding is started by a difference value of a picture order count (POC) from the current sample.

4. The information processing device according to claim 1, wherein
the random access metadata includes control information specifying a sample that is normally decoded.

5. The information processing device according to claim 4, wherein
the control information specifies the sample that is normally decoded by a difference value of a picture order count (POC) from the current sample.

6. The information processing device according to claim 1, wherein
the random access metadata includes first control information specifying a sample from which decoding is started and second control information specifying a sample that is normally decoded.

7. The information processing device according to claim 6, wherein
the first control information specifies the sample from which decoding is started by a difference value of a picture order count (POC) from the current sample, and
the second control information specifies the sample that is normally decoded by a difference value of the POC from the current sample.

8. The information processing device according to claim 1, wherein
the content file manages a submesh of the mesh data as a subsample,
the random access metadata generation unit is configured to generate the random access metadata corresponding to the subsample, and
the storage unit is configured to store the random access metadata corresponding to the subsample in the content file.

9. The information processing device according to claim 8, wherein
the storage unit is configured to store the random access metadata in a subsample information box of the content file.

10. The information processing device according to claim 8, wherein
the random access metadata includes information indicating a coding type of the submesh corresponding to the subsample.

11. The information processing device according to claim 8, wherein
the random access metadata includes control information specifying a subsample from which decoding is started.

12. The information processing device according to claim 11, wherein
the control information specifies the subsample from which decoding is started by a difference value of a picture order count (POC) from a current subsample.

13. The information processing device according to claim 8, wherein
the random access metadata includes control information specifying a subsample that is normally decoded.

14. The information processing device according to claim 13, wherein
the control information specifies the subsample that is normally decoded by a difference value of a picture order count (POC) from a current subsample.

15. The information processing device according to claim 8, wherein
the random access metadata includes first control information specifying a subsample from which decoding is started and second control information specifying a subsample that is normally decoded.

16. The information processing device according to claim 15, wherein
the first control information specifies the subsample from which decoding is started by a difference value of a picture order count (POC) from a current subsample, and
the second control information specifies the subsample that is normally decoded by a difference value of the POC from the current subsample.

17. The information processing device according to claim 1, wherein
the storage unit is configured to store the random access metadata in a track that stores the mesh data of the content file.

18. An information processing method comprising:
generating random access metadata for performing random access on mesh data on a basis of a current sample that is an inter-mesh sample; and
storing the random access metadata in a content file that stores the mesh data.

19. An information processing device comprising:
a random access reproduction control unit that controls random access on a basis of random access metadata for performing the random access on a basis of a current sample that is an inter-mesh sample, the random access metadata being stored in a content file that stores mesh data; and
a reproduction processing unit that starts reproduction of the mesh data by the random access.

20. An information processing method comprising:
controlling random access on a basis of random access metadata for performing the random access on a basis of a current sample that is an inter-mesh sample, the random access metadata being stored in a content file that stores mesh data; and
starting reproduction of the mesh data by the random access.
